(19) United States
(12) Patent Application Publication
(10) Pub. No.: US 2020/0372828 A1
(43) Pub. Date: Nov. 26, 2020

(54) SYSTEM AND PROCESS FOR TEACHING SPEECH TO PEOPLE WITH HEARING AND/OR SPEECH DISABILITIES

(71) Applicant: Sandra Kaul, Rescue, CA (US)

(72) Inventor: Sandra Kaul, Rescue, CA (US)

(21) Appl. No.: 16/420,266

(22) Filed: May 23, 2019

(51) Int. Cl. G09B 19/04; G09B 21/00

(52) U.S. Cl. CPC G09B 19/04; G09B 21/009

(57) ABSTRACT

Systems and processes to teach speech utilizing visual phonemes as physical representations or surrogates of spoken sounds, wherein the visual phonemes also include the letters and letter combinations that are used in a way that sounds the phoneme when spoken and words corresponding to the letter of letter combinations that use the letter or letter combinations therein in a way that sounds the phoneme when spoken.

### STATEMENT REGARDING FEDERALLY SPONSORED RESEARCH OR DEVELOPMENT

Not applicable

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### BACKGROUND OF THE INVENTIVE CONCEPT

### 1. Field of the Invention

The present inventive concept relates to a system for, and process of, teaching individuals with hearing disabilities and/or speech impairments to talk or to express themselves orally with improved intelligibility. More particularly, the present inventive concept relates to a system and process that connects/bridges an individual's previously learned American English language phonemes (distinct units of a sound), via the patented system and process described in Applicant's earlier U.S. Pat. No. 7,172,427, to all letter and letter combinations that make up sounds used in the American English language, in order to help the individual learn to speak, read and spell using the alphabet. In other words, the present inventive concept can be referred to as a set of building blocks to learning all letter and letter combinations that form sounds used in American English language, based on the phonemes previously learned by the teachings of the system and process disclosed in Applicant's earlier U.S. Pat. No. 7,172,427. With the learned distinct units of sounds of the American English language phonemes, the present inventive concept can teach individuals with hearing and/or speech disabilities to become familiar with and use all the letter and letter combinations in the American English language that form the sounds of the American English language, thus helping to teach these individuals to speak, read and spell using all of the letters in the alphabet.

While holding potential for direct application to any individuals who themselves are, or have become, hearing challenged and/or fully or partially incapable of oral communication, the present inventive system and process have been developed for application particularly to children with hearing impairments or other disabilities adversely impacting capability of oral expression. The inventive system and process presented herein, however, are by no means to be considered as limited in scope as to applying only to children.

Across the spectrum of education, for all age levels and types of student subjects, no greater professional challenge exists than that facing a speech pathologist or teacher striving to help a non-hearing child, or speech challenged child to learn to speak. Of course, for the hearing-impaired child, learning to speak certainly is no less a challenge. A great number of such children face this challenge at birth or soon thereafter. From that moment on, their challenge seems insurmountable. After all, how can profoundly deaf children understand anything about speech when they cannot perceive speech sounds, words or phrases, even when shouted?

While deaf children might readily observe the lip movements of those speaking directly to them, they obviously associate no sound with such movements. Lip movements, to them, are thus meaninglessly silent. Beyond that, the input gained by a “hearing child” listening to sounds from an observed speaker is lost on the profoundly deaf. Depending on the level of hearing, the auditory input may be inadequate or non-existent, to be able to make any oral/speech sound associations.

The challenged child will focus instead upon more obvious and imposing movements like gestures or actions. Disadvantaged by an absence or limited reception of auditory models for sounds, the deaf child will most likely either: a) not speak at all, or b) develop a manner of speech that is unintelligible to an unsophisticated public. The challenged child will focus instead upon more obvious and imposing movements like gestures, actions and the surrounding colorful world. Even many hearing children do not cognitively register that the sounds they make are different than the sounds people are saying.

Over the years, innovative therapists, linguists, technologists, teachers and pathologists, and hybrids of two or more of such professions have created helpful tools and processes to address this daunting challenge. They have done so with only limited degrees of success. Still, as will be discussed below, ample room exists for improvement in the educational process. There is a substantial need on the part of educators throughout the world for simpler yet more effective tools.

Teaching strategies, developed and applied with limited or mixed success, have involved phonology, phonetics, and to a limited extent have leveraged the concepts of phonemes. “Phonemes,” in this context, are the individual or distinct units of sounds emitted by speaking. Phonemes are traditionally represented in a phonetic script, wherein each descriptor represents a single phoneme.

For years, linguists and/or speech experts have classified speech sounds into representational categories called phonemes. The American English language finds itself represented by about four dozen phonemes, although the exact count varies due to vast numbers of dialects indigenous to geographic regions. Phoneme descriptors range, for example, from monophthongs and diphthongs covering more than a dozen vowel forms, to consonant depictions categorized as approximants, nasals, fricatives, plosives, and affricates. No two categorized spoken sounds are the same. Ironically, these esoteric descriptors just mentioned seem to a layperson as a language from a distant world, yet they are in fact subset groupings of all spoken language sounds.

An International Phonetic Alphabet, or IPA, was developed and first published in 1888 by the International Phonetic Association, an organization founded by Paul Passy. The IPA was modeled on the 1847 works of Isaac Pitman and Henry Ellis, and eventually was revised in 1993, and again in 2015. The IPA is used by speech pathologists and others to transcribe the spoken word in dictionaries to describe the pronunciation of words, and to depict unwritten languages.

The most current chart showing the standard phonemes of the IPA is referenced as prior art within this application at FIGS. 2A and 2B, to be further discussed below, and may be accessed and reviewed in more detail at an Internet website http://www.internationalphoneticassociation.org (See: Reproduction of the International Phonetic Alphabet. While unknown, or at best little appreciated, by a typical layperson, oral communication fairly flows on the science of the production of phonemes. In brief, it consists of the placement of tongue and teeth within a mouth with specific posture and combines with breath and voicing, which may resonate in the nose or mouth. By stringing these movements and sounds together, they collaborate to form and project the words common to a person's lexicon. In typical oral communications, the listening recipient takes in the uttered phonemes and tones. The recipient hears, interprets, learns, reacts and responds in kind. But, meaningful comprehension and exchange are in no way easy for the hearing or speech impaired, especially if such impairment is significant or profound; nor is it easy for individuals with severe speech sound disorders.

With the aid of the system and process disclosed in U.S. Pat. No. 7,172,427, individuals with hearing and/or speech impairments can learn how to form the sounds of the phonemes of the American English language. However, in order to be capable of speaking full words and phrases, there is much more to be learned, above and beyond forming the sounds of the phonemes alone. More specifically, there are more than 250 letter and letter combinations forming sounds that make up words in the American English language. Each of these sounds is built from previously learned phonemes (the distinct units of a sound).

### 2. Description of the Related Art

U.S. Pat. No. 7,172,427, issued to the instant Applicant of this patent application, teaches a system and process that provides visual phonemes that can be in the form of physical qualities in terms of, for example, colors, shapes, textures, weights, rigidity, flexibility, softness, pliability, or whole/part. FIGS. 1a-e illustrate visual phonemes according to the teachings of U.S. Pat. No. 7,172,427. Each phoneme is displayed with a unique shape along with a uniquely identifiable color. In this teaching, spoken sounds in the form of vowels (FIGS. 1-a and 1-b) are disclosed to be represented by distinctive ranges of color hues, such as by colors commonly characterized in the art as warm. For example, warm colors include red, pink, orange, gold and yellow, and variants of each of these colors. In addition, spoken sounds in the form of consonants (FIGS. 1-c, d, e) are disclosed to also be represented by distinctive ranges of color hues, such as by colors commonly characterized in the art as cool. For example, cool colors include purple, blue, green, turquoise, gray, silver and white, and variants of each of these colors.

Additionally, each of the approximately 40 phonemes shown in FIGS. 1a-e (in the American English language) is labeled in such a way as to be correlated with the International Phonetic Association Alphabet, or IPA (see IPA Prior art as presented in FIG. 2). For example, in FIG. 1-c, visual phoneme 2 is designated as royal blue in color 3, and carries the IPA correlation, “[m]” as indicated by reference character 4. See U.S. Pat. No. 7,172,427 for the full teachings and disclosure of the system and process that teaches individuals with hearing impairments and/or speech complications the 40 primary phonemes of the American English language.

What is needed is a system and process that bridges/connects the at least 250 letter and letter combinations, which make up the sounds in the American English language, to the previously learned 40 or more phonemes of the American English language, in order to teach individuals with hearing impairments and/or speech difficulties how each of the at least 250 letter and letter combinations are associated with, and formed by the approximately 40 phonemes of the American English language. Such a system and process will help such individuals to speak each of these 250 letter and letter combinations, which will in effect help these individuals to learn how to pronounce all versions of letters and letter combinations to form words, and hence to learn to speak in phrases.

### SUMMARY OF THE INVENTIVE CONCEPT

The present general inventive concept provides a system and process to teach individuals with hearing disabilities and/or speech impairments to talk, read and spell using the alphabet. More particularly, the present inventive concept provides a system and process that connects/bridges an individual's previously learned American English language phonemes to all letter and letter combinations that make up words in the American English language, in order to help the individual learn to read and spell using the alphabet.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a system for teaching speech to individuals with hearing or speech disabilities using phonemes, the system comprising: a plurality of index cards each comprising: a unique phoneme disposed thereon, a unique shape disposed thereon to represent the unique phoneme, the unique shape having a unique color also to represent the unique phoneme, every letter and combination of letters used in the American English language which form the sound of the unique phoneme when spoken, the every letter and combination of letters being provided in the unique color, and one or more words adjacent to each of the letters and combination of letters thereon, the words being words using the letter or combination of letters therein in a way in which the phoneme is sounded when spoken.

In an exemplary embodiment, the system may further comprise a kit to contain each of the index cards in a predetermined order.

In an exemplary embodiment, the plurality of index cards may each comprise a tab at a top portion thereof and at an opposite side from an adjacent index card such that each of the tabs of the index cards are fully in view while the plurality of index cards are disposed in the kit.

In an exemplary embodiment, each of the tabs of the plurality of index cards may include the shape and color thereon which represent the respective phoneme, a word with a letter or combination of letters which sound the phoneme, and the respective phoneme adjacent thereto.

The foregoing and/or other features and utilities of the present general inventive concept may also be achieved by providing a system for teaching speech to individuals with hearing or speech disabilities using phonemes, the system comprising: a plurality of three dimensional elements each comprising: a unique phoneme disposed thereon, a unique shape to represent the respective unique phoneme, the unique shape having a unique color also to represent the respective unique phoneme, a letter or combination of letters used in the American English language which are used to speak the sound of the unique phoneme, the letter or combination of letters being provided in the unique color, and one or more words adjacent each of respective ones of the letter or combination of letters, the words being ones which use the letter or combination of letters therein in a way in which the phoneme is sounded when spoken

In an exemplary embodiment, the system may further comprise a kit to contain each of the three dimensional elements therein, the kit being enclosed by a front surface, a back surface, two sides and a cover, the cover being rotatable with respect to the back surface to expose the three dimensional elements therein.

In an exemplary embodiment, the three dimensional elements can be formed of a magnetic material and the inside of the cover is formed of a magnetically attractive metal to magnetically attract the three dimensional elements thereto.

In an exemplary embodiment, a back surface of the three dimensional elements and the inside surface of the cover can be formed of a hook and loop system such that the three dimensional elements attract to and stick to the inside surface of the cover.

In an exemplary embodiment, the three dimensional elements can be formed of a flexible material.

In an exemplary embodiment, the three dimensional elements can be formed of a felt material.

In an exemplary embodiment, the three dimensional elements can be formed of a rubber material.

The foregoing and/or other features and utilities of the present general inventive concept may also be achieved by providing a process of teaching speech to individuals with hearing or speech disabilities, the process comprising: providing a plurality of two dimensional objects each including a unique phoneme disposed thereon; providing a unique shape disposed on each of the objects to represent the respective phoneme, each unique shape having a unique color also to represent the respective phoneme; providing letters and combinations of letters on each of the objects which are used in the American English language to sound the respective phoneme when spoken, the letters and combinations of letters being provided in the unique colors representing the phoneme, and providing one or more words adjacent to each of the respective letters and combinations of letters which include the adjacent letter or combination of letters therein in a way in which the phoneme is sounded when spoken.

The foregoing and/or other features and utilities of the present general inventive concept may also be achieved by providing a process for teaching speech to individuals with hearing or speech disabilities using phonemes, the process comprising: providing a plurality of three dimensional objects in a unique shape and color: providing a unique phoneme on each of the three dimensional objects; providing letters and combinations of letters used in the American English language which are used to sound of the respective phoneme when spoken; and providing one or more words adjacent to each of the respective letters and combinations of letters which include the adjacent letter or combination of letters therein in a way in which the phoneme is sounded when spoken.

The foregoing and/or other features and utilities of the present general inventive concept may also be achieved by providing a non-transitory computer-readable medium comprising instructions executed by a processor to: providing a plurality of three dimensional objects in a unique shape and color: providing a unique phoneme on each of the three dimensional objects; providing letters and combinations of letters used in the American English language which are used to sound the respective phoneme when spoken; and providing one or more words adjacent to each of the respective letters and combinations of letters which include the adjacent letter or combination of letters therein in a way in which the phoneme is sounded when spoken.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIGS. 1A through 1E illustrate a system and process, according to related art, for teaching speech to people with hearing or speech disabilities.

FIG. 2A illustrates a table of the International Phonetic Association Alphabet (IPA) for vowels, according to prior art.

FIG. 2B illustrates a table of the International Phonetic Association Alphabet (IPA) for consonants, according to the prior art.

FIGS. 3A through 3Q illustrate a system and process for teaching all of the American English language phoneme vowel and vowel combination sounds to those with hearing and/or speech disabilities, according to an exemplary embodiment of the present inventive concept.

FIG. 4A through 4X illustrate a system and process for teaching all of the American English language consonant sound combinations to those with hearing and/or speech disabilities, according to an exemplary embodiment of the present inventive concept.

FIG. 5 illustrates an exemplary embodiment of a system for teaching all of the American English language vowel sound combinations to those with hearing and/or speech disabilities, according to an exemplary embodiment of the present inventive concept.

FIGS. 6A through 6C illustrate a system and process for teaching all of the American English language phoneme vowel and vowel combination sounds to those with hearing and/or speech disabilities, according to another exemplary embodiment of the present inventive concept.

FIGS. 6D through 6F illustrate a system and process for teaching all of the American English language consonant and consonant combination sounds to those with hearing and/or speech disabilities, according to another exemplary embodiment of the present inventive concept.

FIG. 6G illustrates an exemplary embodiment of a system for teaching all of the American English language vowel sound combinations to those with hearing and/or speech disabilities, according to another exemplary embodiment of the present inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept may be omitted, but are by no means outside the spirit and scope of the present inventive concept as described herein.

It will be understood that although terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of this disclosure.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description herein. Thus, the terms used herein have to be defined based on the meaning of the terms together with the descriptions throughout this specification.

Also, when a part “includes” or “comprises” an element, unless there is a particular description contrary thereto, the part can further include other elements, not excluding the other elements.

Hereinafter, one or more exemplary embodiments of the present general inventive concept will be described in detail with reference to accompanying drawings.

Exemplary embodiments of the present general inventive concept are directed to both two and three dimensional systems and processes that bridge/connect an individual's learning of the 40 or more American English language phonemes, represented by shapes and color combinations disclosed in Applicant's prior patented system and process disclosed in Applicant's previously issued U.S. Pat. No. 7,172,427, to the at least 250 letter and letter combinations that make up the sounds in the American English language. Thus, the exemplary embodiments of the present inventive concept provide both two and three dimensional systems and processes that bridge/connect the at least 250 letter and letter combinations which make up the sounds to form words in the American English language, to the visually created phonemes disclosed in teaching of Applicant's U.S. Pat. No. 7,172,427. Thus the exemplary embodiments of the present inventive concept help to teach individuals with profound hearing impairments or other disabilities limiting speech capabilities each of the letter and letter combinations that form sounds of the American English language, and to help these individuals to speak, read and spell using the alphabet. The present system and process, as described herein, can be utilized along with or in conjunction with known or conventional methods and tools for teaching individuals phonemic awareness and articulation of speech and sounds.

As with Applicant's previous system and process disclosed in U.S. Pat. No. 7,172,427, hearing-challenged individuals and individuals with speech sound disorders are the principal targets for this present inventive system and process. While the Applicant's issued U.S. Pat. No. 7,172,427 provides a system and process to learn sounds from visual phonemes (i.e., specific shapes and colors), the present inventive system and process can be referred to generally as the bridging of the 250 or more American English language “letter and letter combinations” used to form words to the visually formed phonemes taught in the system and process disclosed in U.S. Pat. No. 7,172,427.

It is to be noted that although specific colors and shapes are disclosed herein to represent certain American English language phonemes and letter and letter combinations, the present inventive concept is not limited to this specific arrangement, and can alternatively use other colors and shapes to represent each of the American English language phonemes together with letter and letter combinations used in the American English language, while still remaining within the spirit and scope of the present inventive concept as disclosed herein.

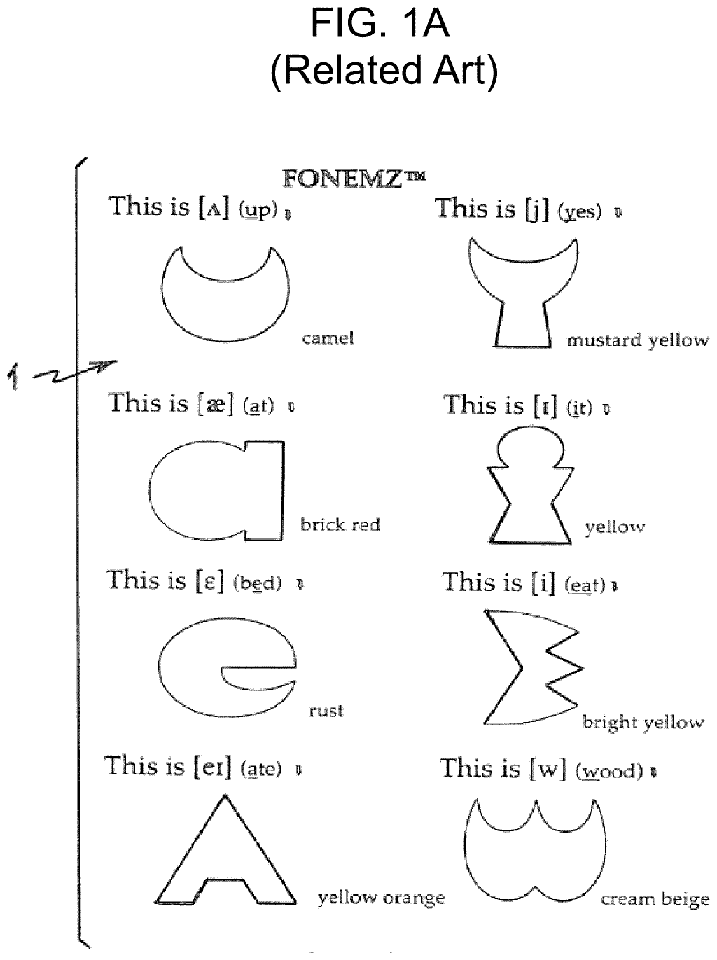

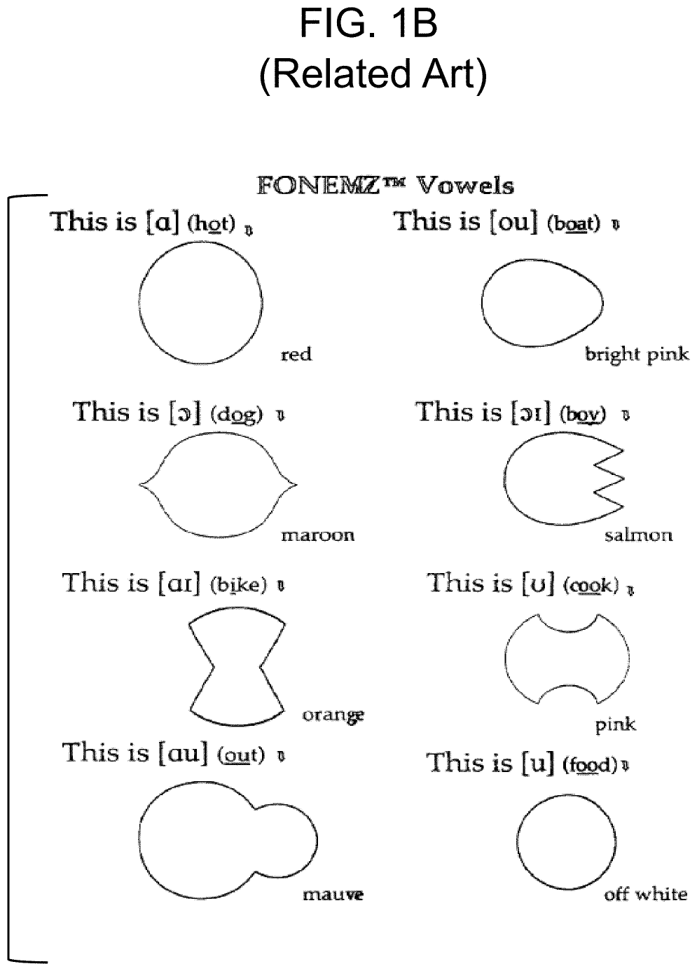

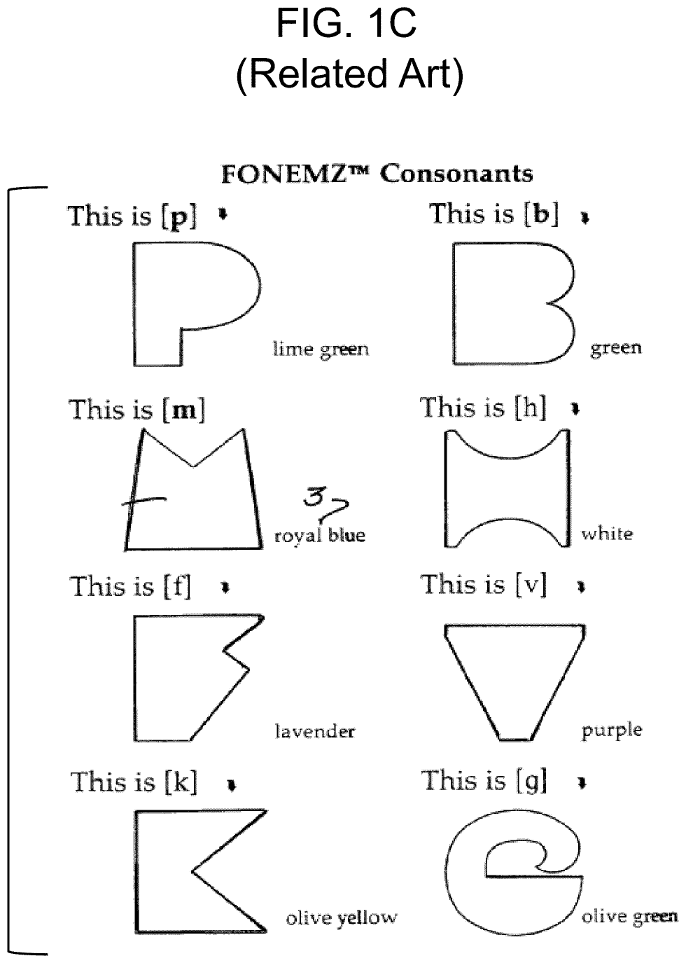

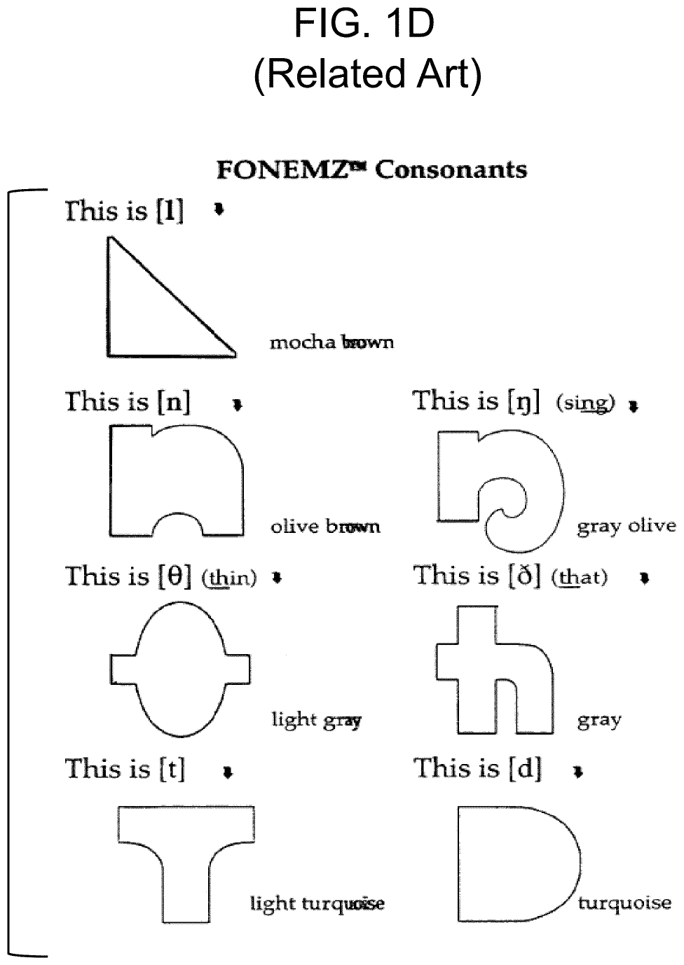

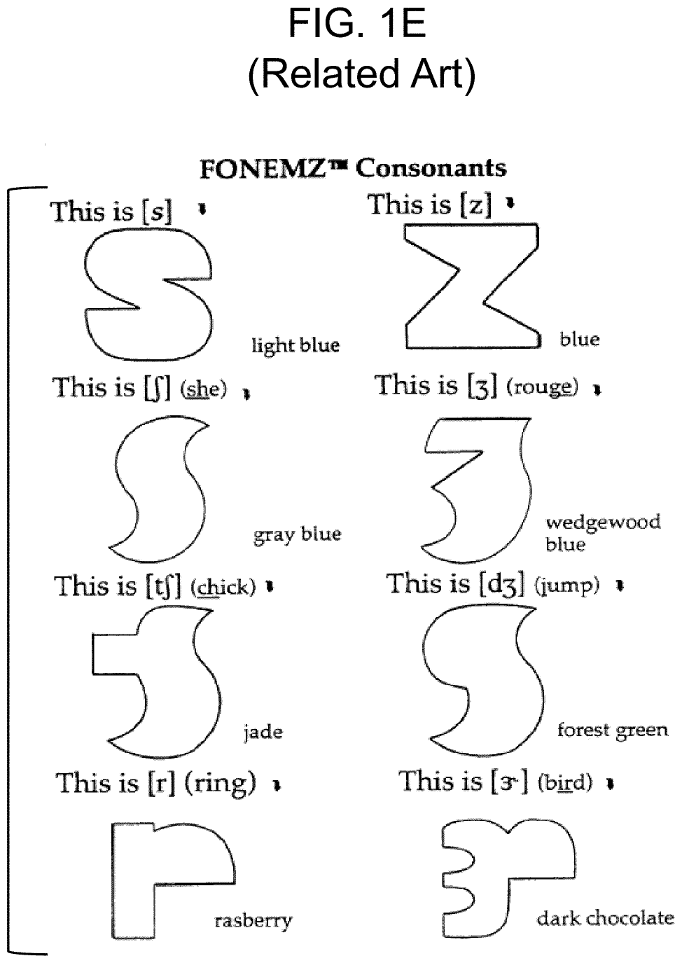

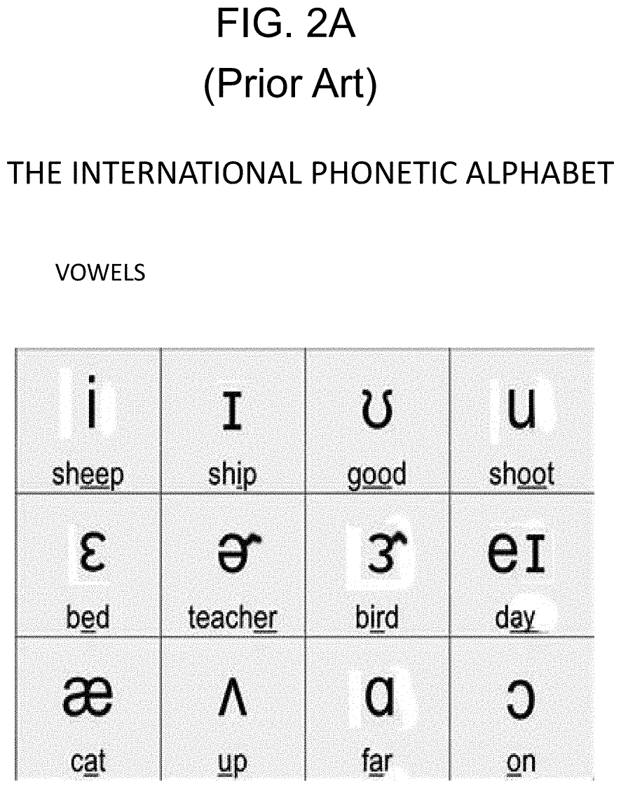

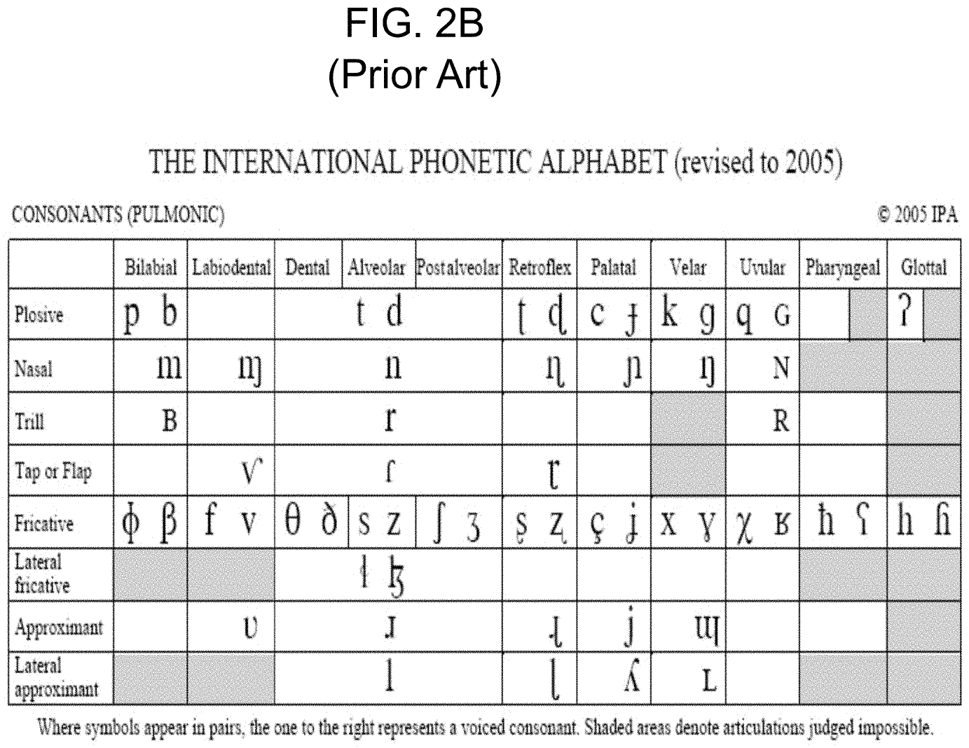

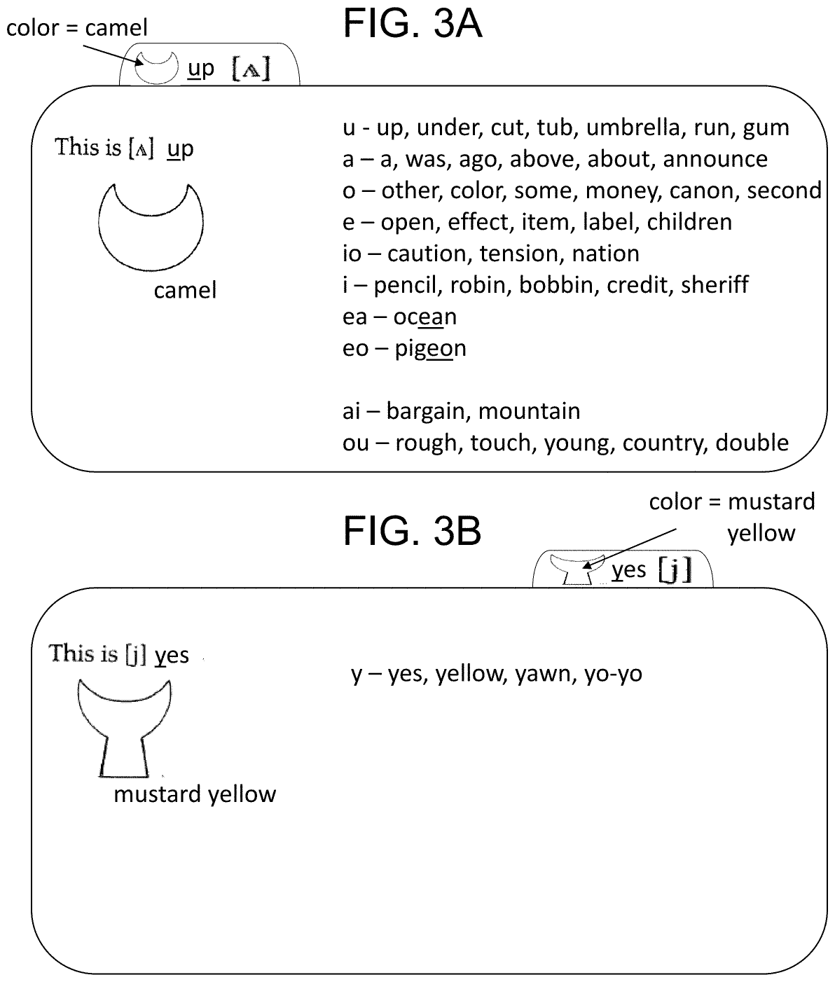

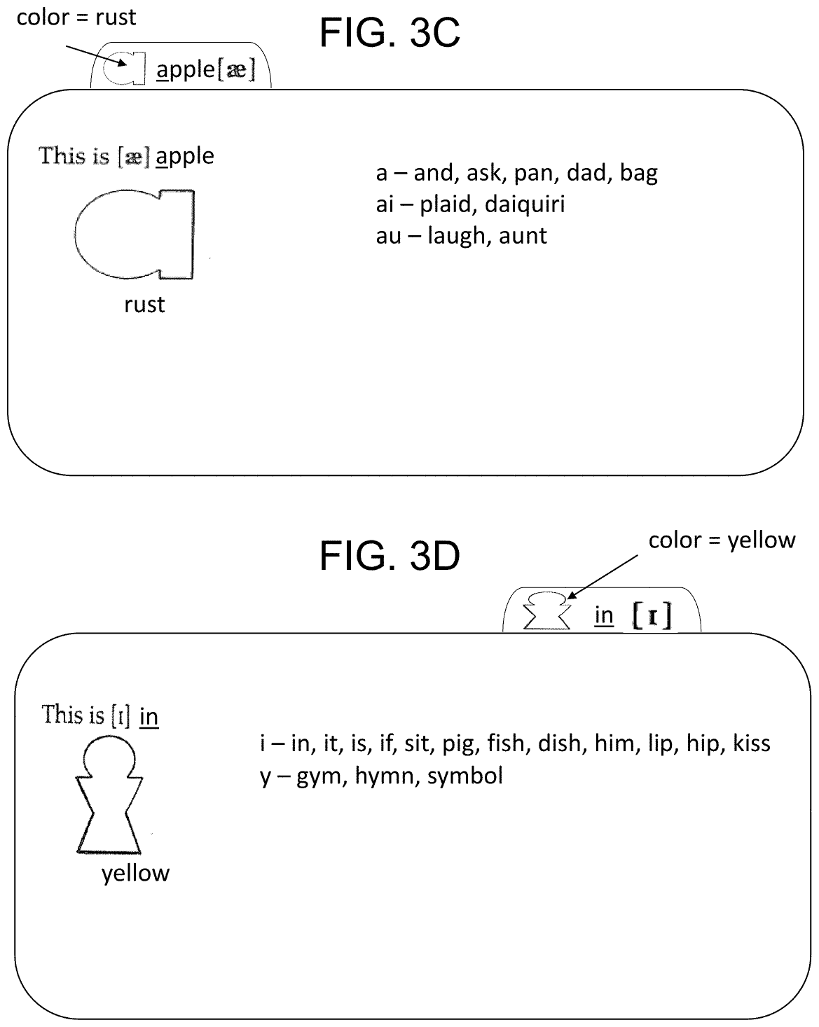

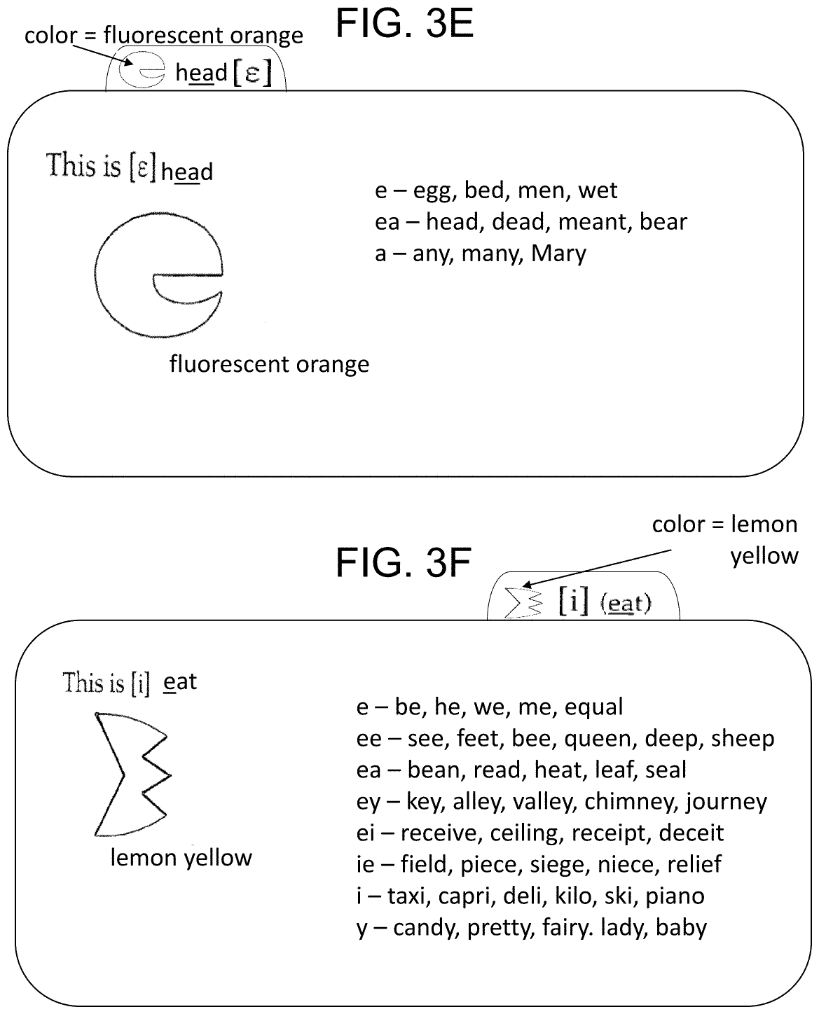

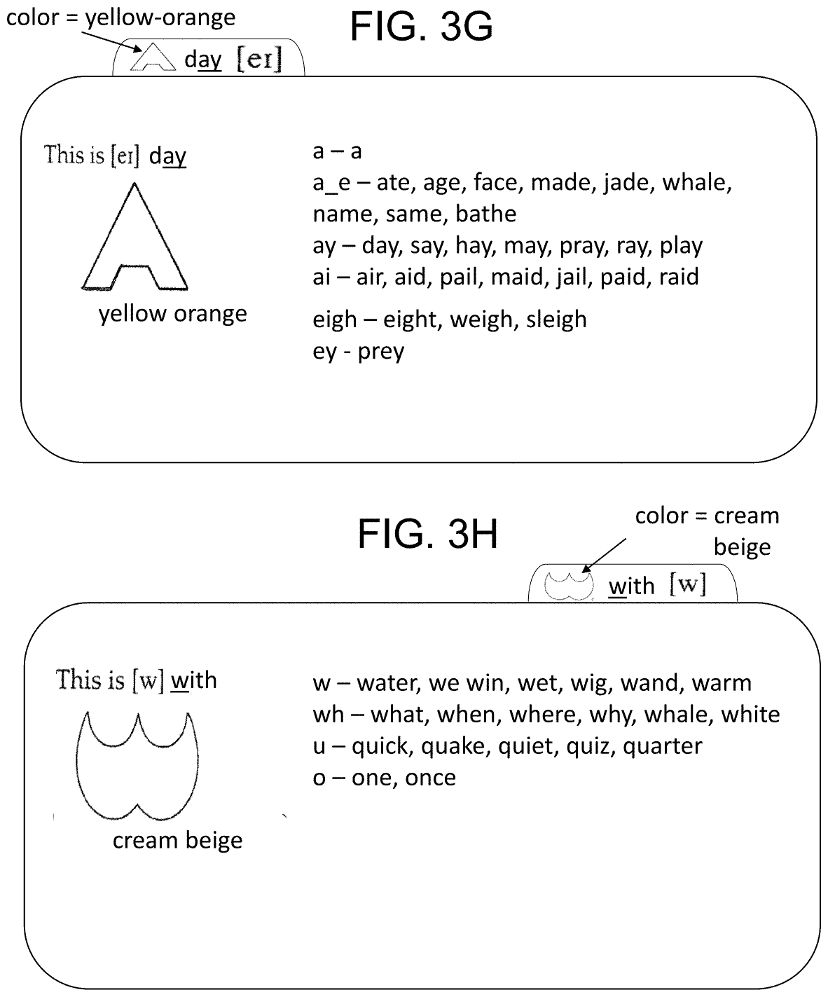

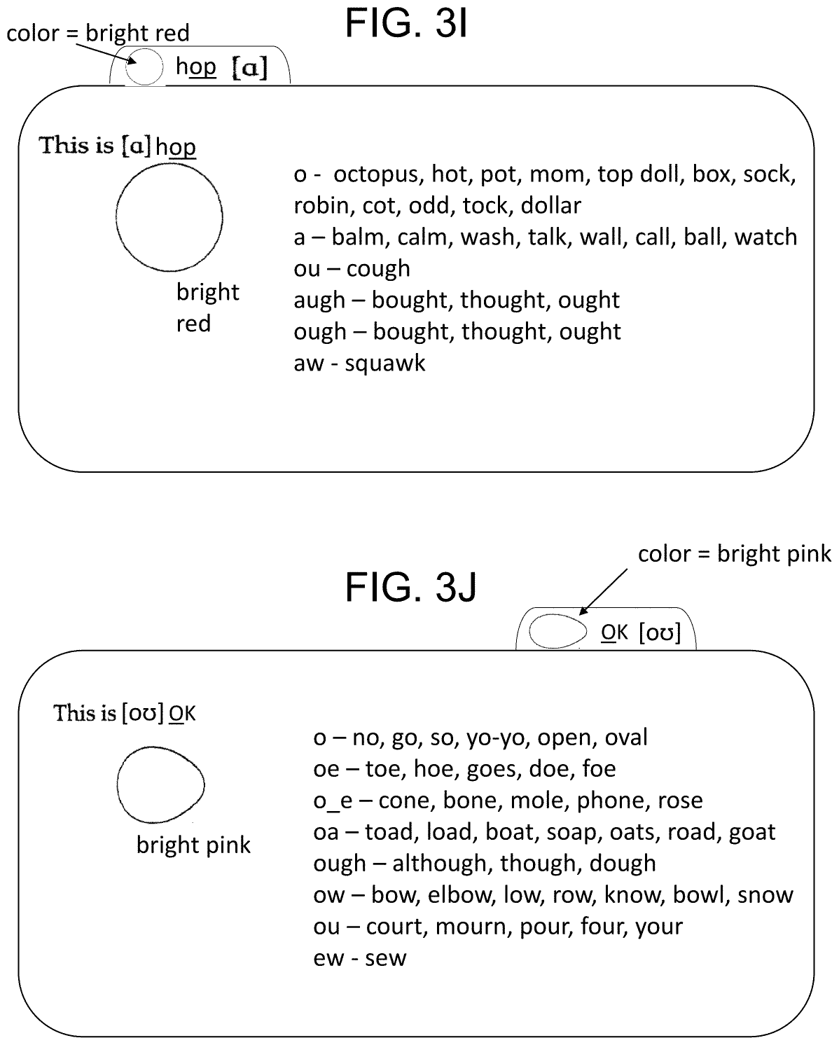

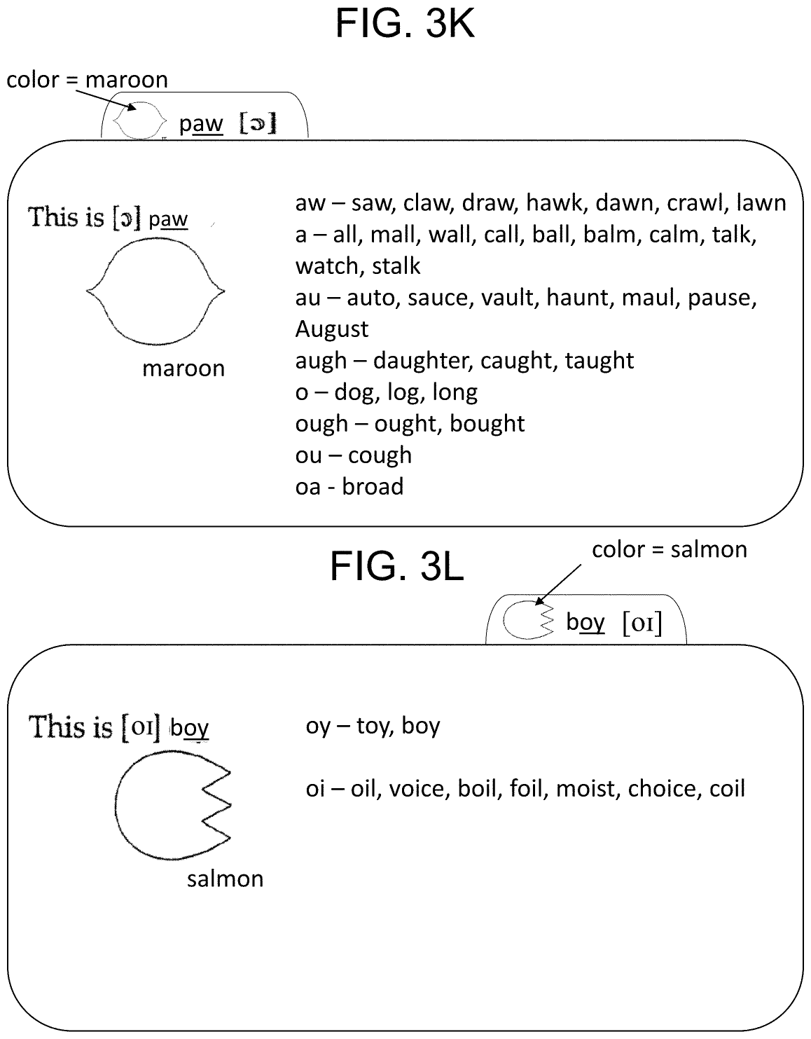

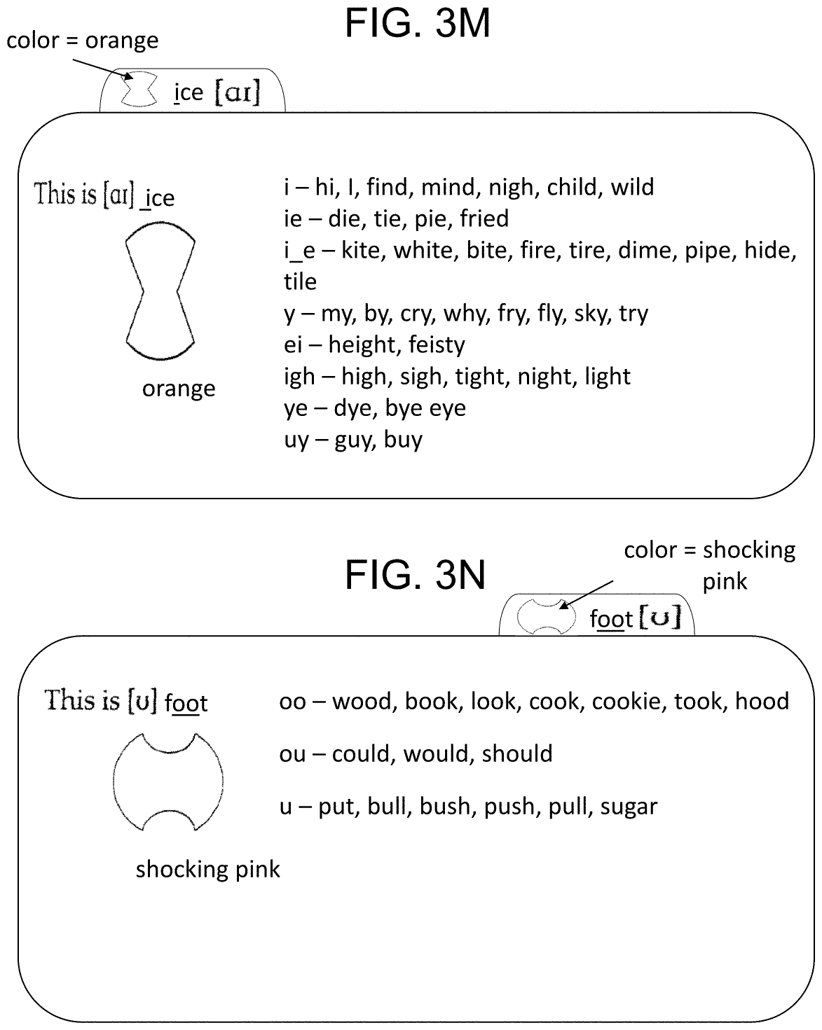

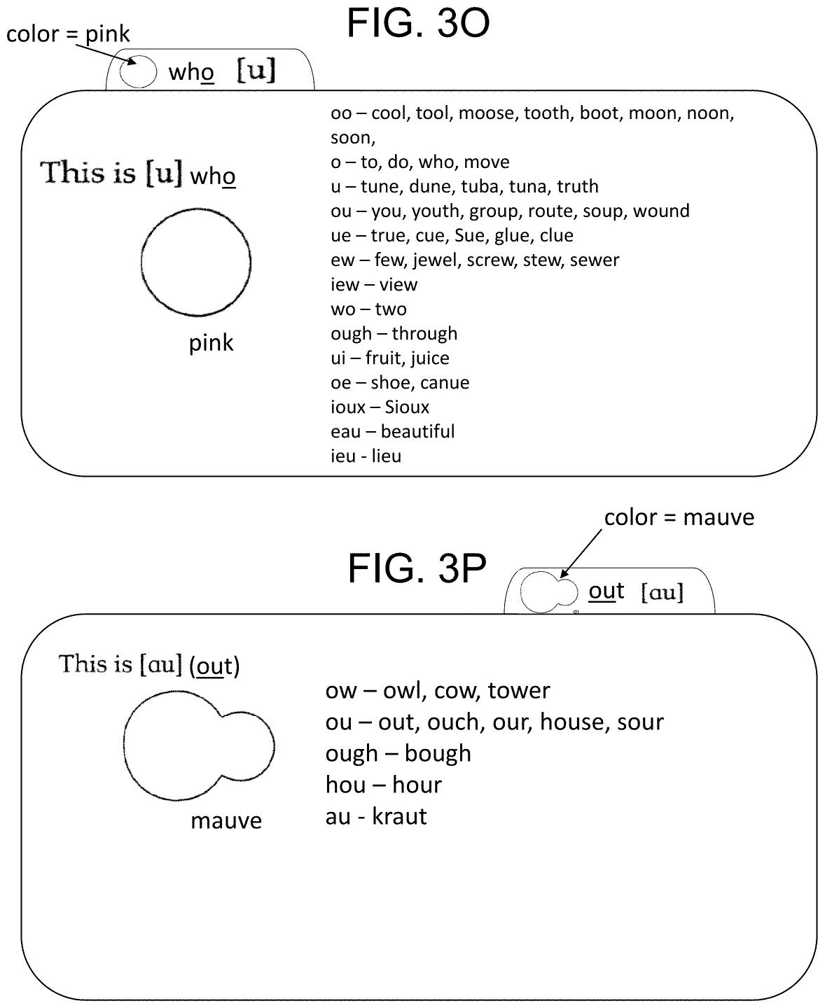

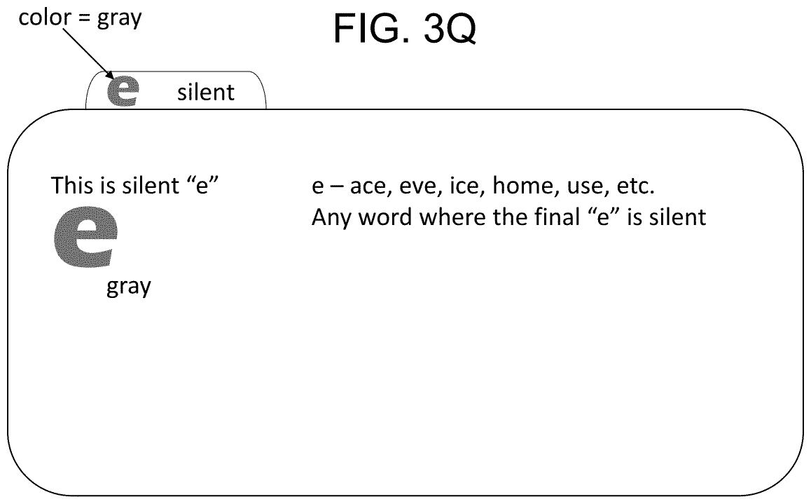

FIG. 3A illustrates the phoneme [Λ] from the International Phonetic Chart illustrated in FIG. 2A. This phoneme is pronounced like the vowel “u,” as used in the word “up.” In accordance with FIG. 1A of the related art, as disclosed in Applicant's U.S. Pat. No. 7,172,427, this phoneme [Λ] is represented by the color “camel” together with the shape [symbol] . FIG. 3A of the present inventive concept illustrates each of the possible letters and letter combinations that can have the sound of the phoneme [Λ]. As illustrated, these letters and letter combinations include u, a, o, e, io, i, ea, eo, ai and ou. As such, the present inventive concept provides an indicator card (FIG. 3A) showing these letters and letter combinations, together with applications of these letters and letter combinations used in words having the sound of the phoneme [Λ], thus helping individuals with hearing impairments and other speech difficulties to pronounce these sounds and words correctly according to the American English language. Although this phoneme [Λ] is represented by the color “camel” together with the shape [symbol] in this exemplary embodiment, the phoneme [Λ] could be represented by another color and shape without departing from the principles and spirit of the present inventive concept.

FIG. 3B illustrates the phoneme [j] from the International Phonetic Chart illustrated in FIG. 2A. This phoneme is pronounced with the vowel “y,” as used in the word “yes.” In accordance with FIG. 1A as disclosed in Applicant's U.S. Pat. No. 7,172,427, this phoneme [j] is represented by the color “mustard yellow” together with the shape [symbol] FIG. 3B of the present inventive concept illustrates each of the possible letters that can have the sound of the phoneme [j]. As illustrated, these letters include only the letter “y.” As such, the present inventive concept provides an indicator card (FIG. 3B) showing this letter “y” together with applications of this letter used in words having the sound of the phoneme [j], thus helping individuals with hearing impairments and other speech difficulties to pronounce these sounds and words correctly according to the American English language.

FIG. 3C illustrates the phoneme [æ] from the International Phonetic Chart illustrated in FIG. 2A. This phoneme is pronounced like the vowel “a,” as used in the word “at.” In accordance with FIG. 1A as disclosed in Applicant's U.S. Pat. No. 7,172,427, this phoneme [æ] is represented by the color “rust” together with the shape [symbol] . FIG. 3C of the present inventive concept illustrates each of the possible letters and letter combinations that can have the sound of the phoneme [æ]. As illustrated, the letter and letter combinations include a, ai and au. As such, the present inventive concept provides an indicator card (FIG. 3C) showing these letter and letter combinations, together with applications of these letter and letter combinations used in words having the sound of the phoneme [æ], thus helping individuals with hearing impairments and other speech difficulties to pronounce these sounds and words correctly according to the American English language.

FIG. 3D illustrates the phoneme [I] from the International Phonetic Chart illustrated in FIG. 2A. This phoneme is pronounced like the vowel “i,” as used in the word “it.” In accordance with FIG. 1A of the related art as invented and by Applicant, this phoneme is represented by the color “yellow” together with the shape [symbol] . FIG. 3D of the present inventive concept illustrates each of the possible letters that can have the sound of the phoneme [I]. These letters include i and y. As such, the present inventive concept provides an indicator card (FIG. 3D) showing these letters as well as applications of these letters used in words having the sound of the phoneme [I], thus helping individuals with hearing impairments and other speech difficulties to pronounce these sounds and words correctly according to the American English language.

FIG. 3E illustrates the phoneme [ε] pronounced like the vowel “e,” as used in the word “bed.” In accordance with FIG. 1A as disclosed in Applicant's U.S. Pat. No. 7,172,427, this phoneme is represented by the color “fluorescent orange” and with the shape [symbol] . FIG. 3E of the present inventive concept illustrates each of the possible letters and letter combinations that can have the sound of the phoneme [ε]. These letters and letter combinations include e, ea and a. As such, the present inventive concept provides an indicator card (FIG. 3E) showing these letters and letter combination, as well as applications of these letters and letter combination used in words having the sound of the phoneme [ε], thus helping individuals with hearing impairments and other speech difficulties to pronounce these sounds and words correctly according to the American English language.

FIG. 3F illustrates the phoneme [i] pronounced like the combined vowels “ea,” as used in the word “eat.” In accordance with FIG. 1A as disclosed in Applicant's U.S. Pat. No. 7,172,427, this phoneme is represented by the color “lemon yellow” together with the shape [symbol] . FIG. 3F of the present inventive concept illustrates each of the possible letters and letter combinations that can have the sound of the phoneme [i]. These letters and letter combinations include e, ee, ea, ey, ei, ie, i, y. As such, the present inventive concept provides an indicator card (FIG. 3F) showing these letters and letter combinations, as well as applications of these letter and letter combinations used in words having the sound of the phoneme [i], thus helping individuals with hearing impairments and other speech difficulties to pronounce these sounds and words correctly according to the American English language.

FIG. 3G illustrates the phoneme [eI] pronounced like the vowel “a,” as used in the word “day.” In accordance with FIG. 1A of the related art as invented by Applicant, this phoneme is represented by the color “yellow orange” together with the shape [symbol] . FIG. 3G of the present inventive concept illustrates each of the possible letters and letter combinations that can have the sound of the phoneme [eI]. These letters and letter combinations include a, a_e, ay, ai, ea, ei, eigh and ey. As such, the present inventive concept provides an indicator card (FIG. 3G) showing these letters and letter combinations, as well applications of these letters and letter combinations having the sound of the phoneme [eI], thus helping individuals with hearing impairments and other speech difficulties to pronounce these sounds and words correctly according to the American English language.

FIG. 3H illustrates the phoneme [w] pronounced like the vowel “w,” as used in the word “with.” In accordance with FIG. 1A as disclosed in Applicant's U.S. Pat. No. 7,172,427, this phoneme is represented by the color “cream beige” together with the shape [symbol] . FIG. 3H of the present inventive concept illustrates each of the possible letters and letter combinations that can have the sound of the phoneme [w]. These letters and letter combinations include w, wh, u and o. As such, the present inventive concept provides an indicator card (FIG. 3H) showing these letters and letter combination, as well as applications of these letters and letter combination used in words having the sound of the phoneme [w], thus helping individuals with hearing impairments and other speech difficulties to pronounce these sounds and words correctly according to the American English language.

FIG. 3I illustrates the phoneme [ [symbol] ] pronounced like the vowel “o,” as used in the word “hot.” In accordance with FIG. 1A as disclosed in Applicant's U.S. Pat. No. 7,172,427, this phoneme is represented by the color “bright red” together with the shape [symbol] . FIG. 3I of the present inventive concept illustrates each of the possible letters and letter combinations that can have the sound of the phoneme [ [symbol] ]. These letters and letter combinations include o, a, ou, augh, ough and aw. As such, the present inventive concept provides an indicator card (FIG. 3I) showing these letters and letter combinations, as well as applications of these letters and letter combinations used in words having the sound of the phoneme [ [symbol] ], thus helping individuals with hearing impairments and other speech difficulties to pronounce these sounds and words correctly according to the American English language.

FIG. 3J illustrates the phoneme [ou] pronounced like the combination of vowels “oa,” as in the word “boat.” In accordance with FIG. 1A as disclosed in Applicant's U.S. Pat. No. 7,172,427, this phoneme is represented by the color “bright pink” together with the shape [symbol] . FIG. 3J of the present inventive concept illustrates each of the possible letter and letter combinations that can have the sound of the phoneme [ou]. These letter and letter combinations include o, oe, o_e, oa, ough, ow and ou. As such, the present inventive concept provides an indicator card (FIG. 3J) showing these letter and letter combinations, as well as applications of these letter and letter combinations used in words having the sound of the phoneme [ou], thus helping individuals with hearing impairments and other speech difficulties to pronounce both these sounds and words correctly according to the American English language.

FIG. 3K illustrates the phoneme [ [symbol] ] pronounced like the vowels “o,” as used in the word “dog.” In accordance with FIG. 1A as disclosed in Applicant's U.S. Pat. No. 7,172,427, this phoneme is represented by the color “maroon” and with the shape [symbol] FIG. 3K of the present inventive concept illustrates each of the possible letters and letter combinations that can have the sound of the phoneme [ [symbol] ]. These letters and letter combinations include aw, a, au, augh, o, ough, ou and oa. As such, the present inventive concept provides an indicator card (FIG. 3K) showing these letters and letter combinations as well as applications of these letter and letter combinations used in words having the sound of the phoneme [ [symbol] ], thus helping individuals with hearing impairments and other speech difficulties to pronounce both these sounds and words correctly according to the American English language.

FIG. 3L illustrates the phoneme [oI] pronounced with the combination of vowels “oI,” as in the word “boy.” In accordance with FIG. 1A as disclosed in Applicant's U.S. Pat. No. 7,172,427, this phoneme is represented by the color “salmon” together with the shape [symbol] . FIG. 3L of the present inventive concept illustrates each of the possible letter combinations that can have the sound of the phoneme [oI]. These letter combinations include oy and oi. As such, the present inventive concept provides an indicator card (FIG. 3L) showing these letter combinations as well as applications of these letter combinations used in words having the sound of the phoneme [oI], thus helping individuals with hearing impairments and other speech difficulties to pronounce both these sounds and words correctly according to the American English language.

FIG. 3M illustrates the phoneme [αI] pronounced like the vowel “i,” as in the word “bike.” In accordance with FIG. 1A as disclosed in Applicant's U.S. Pat. No. 7,172,427, this phoneme is represented by the color “orange” together with the shape [symbol] . FIG. 3M of the present inventive concept illustrates each of the possible letters and letter combinations that can have the sound of the phoneme [αI]. These letters and letter combinations include i, ie, i_e, y, ei, igh, ye and uy. As such, the present inventive concept provides an indicator card (FIG. 3M) showing these letters and letter combinations as well as applications of these letters and letter combinations used in words having the sound of the phoneme [αI], thus helping individuals with hearing impairments and other speech difficulties to pronounce both these sounds and words correctly according to the American English language.

FIG. 3N illustrates the phoneme [ [symbol] ] pronounced like the combination of vowels “oo,” as in the word “foot.” In accordance with FIG. 1A as disclosed in Applicant's U.S. Pat. No. 7,172,427, this phoneme is represented by the color “shocking pink” together with the shape [symbol] . FIG. 3N of the present inventive concept illustrates each of the possible letters and letter combinations that can have the sound of the phoneme [ [symbol] ]. These letters and letter combinations include oo, ou and u. As such, the present inventive concept provides an indicator card (FIG. 3N) showing the letter and letter combinations as well as applications of these letter and letter combinations used in words having the sound of the phoneme [ [symbol] ], thus helping individuals with hearing impairments and other speech difficulties to pronounce both these sounds and words correctly according to the American English language.

FIG. 3O illustrates the phoneme [u] pronounced like the vowel “o,” as used in the word “who.” In accordance with FIG. 1A as disclosed in Applicant's U.S. Pat. No. 7,172,427, this phoneme [u] is represented by the color “pink” together with the shape [symbol] FIG. 3O of the present inventive concept illustrates each of the possible letter and letter combinations that can have the sound of the phoneme [u]. These letters and letter combinations include oo, u, ue, ew, iew, wo, ough, iu, oe, ioux, eau and ieu. As such, the present inventive concept provides an indicator card (FIG. 3O) showing these letters and letter combinations as well as applications of these letter and letter combinations used in words having the sound of the phoneme [u], thus helping individuals with hearing impairments and other speech difficulties to pronounce both these sounds and words correctly according to the American English language.

FIG. 3P illustrates the phoneme [αu] pronounced like the combination of vowels “au,” as used in the word “ouch.” In accordance with FIG. 1A as disclosed in Applicant's U.S. Pat. No. 7,172,427, this phoneme [αu] is represented by the color “mauve” together with the shape [symbol] FIG. 3P of the present inventive concept illustrates each of the possible letter combinations that can have the sound of the phoneme [αu]. These letter combinations include ow, ou, ough, hou and au. As such, the present inventive concept provides an indicator card (FIG. 3P) showing these letter combinations as well as applications of these letter combinations used in words having the sound of the phoneme [αu], thus helping individuals with hearing impairments and other speech difficulties to pronounce both these sounds and words correctly according to the American English language.

FIG. 3Q illustrates the letter [e], which is silent. This silent [e] is represented by the color “gray” together with the shape [symbol] . FIG. 3Q of the present inventive concept illustrates the letter that is used for the silent [e]. The letter in this case is “e.” As such, the present inventive concept provides words in which the letter “e” is silent, thus helping individuals with hearing impairments and other speech difficulties to pronounce the words correctly according to the American English language.

It is to be noted that although a specific color and specific shape in accordance the examplary embodiment illustrated in FIGS. 3A through 3P is used to represent each of the vowel phonemes listed in the International Phonetic Alphabet illustrated in FIG. 2A, each of these vowel phonemes could be represented by another color and/or shape without departing from the principles and spirit of the present inventive concept.

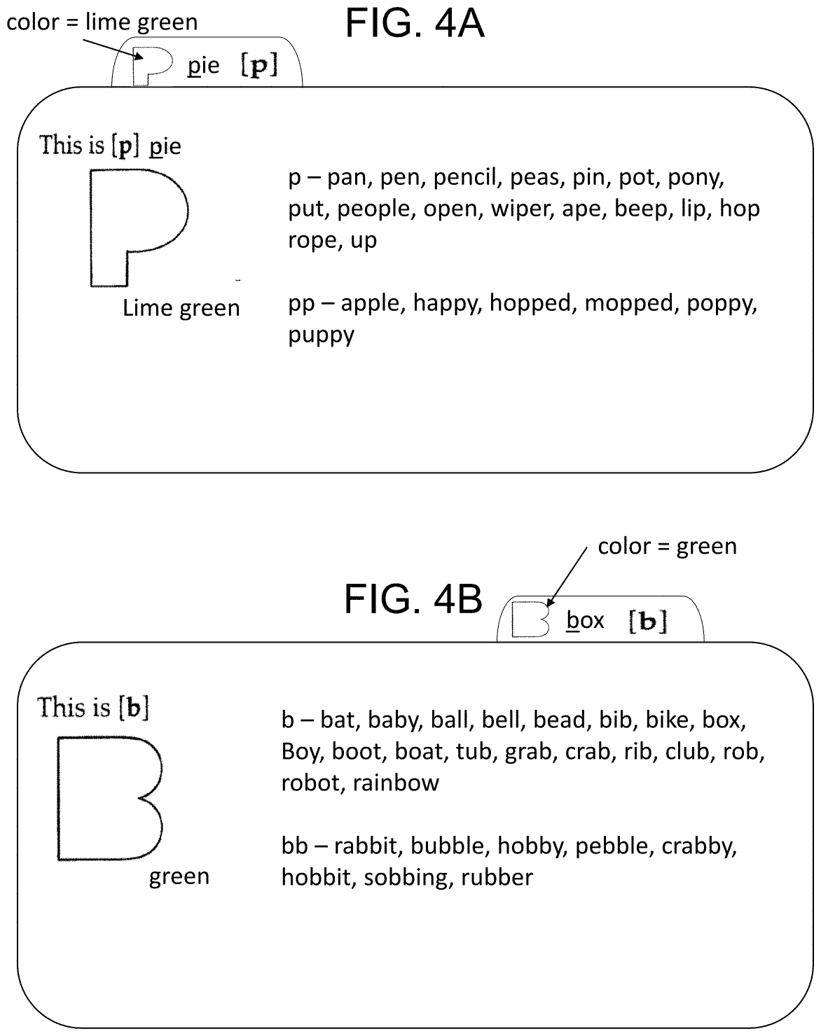

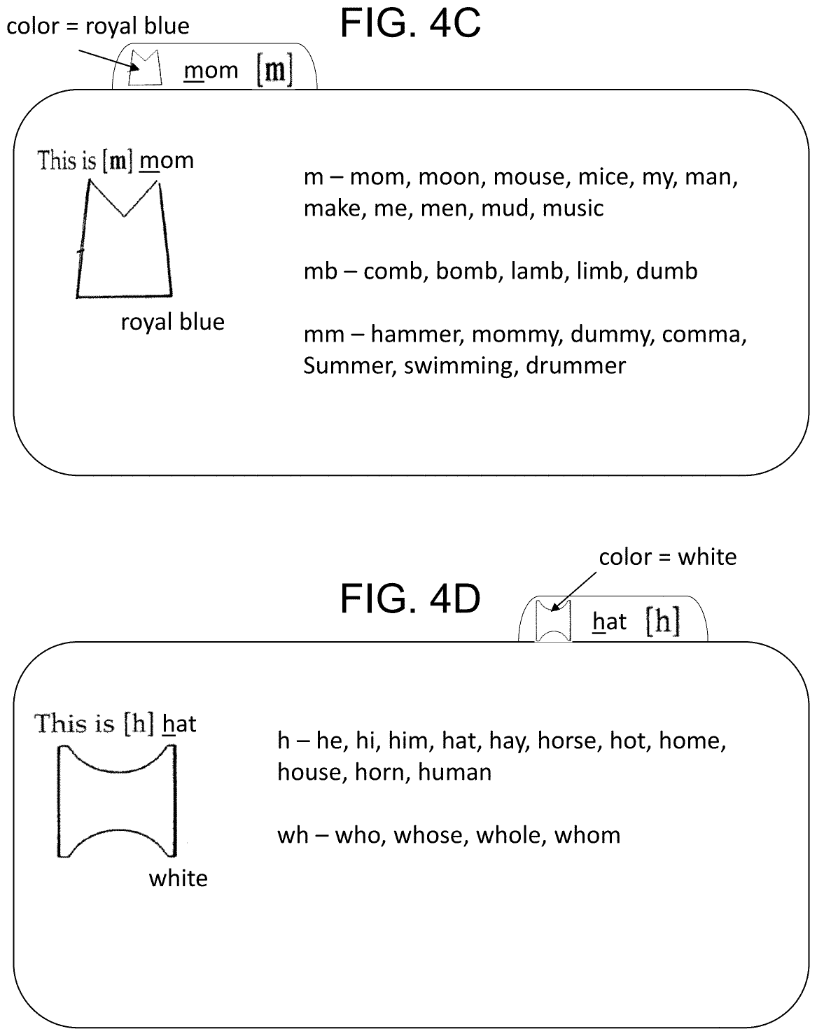

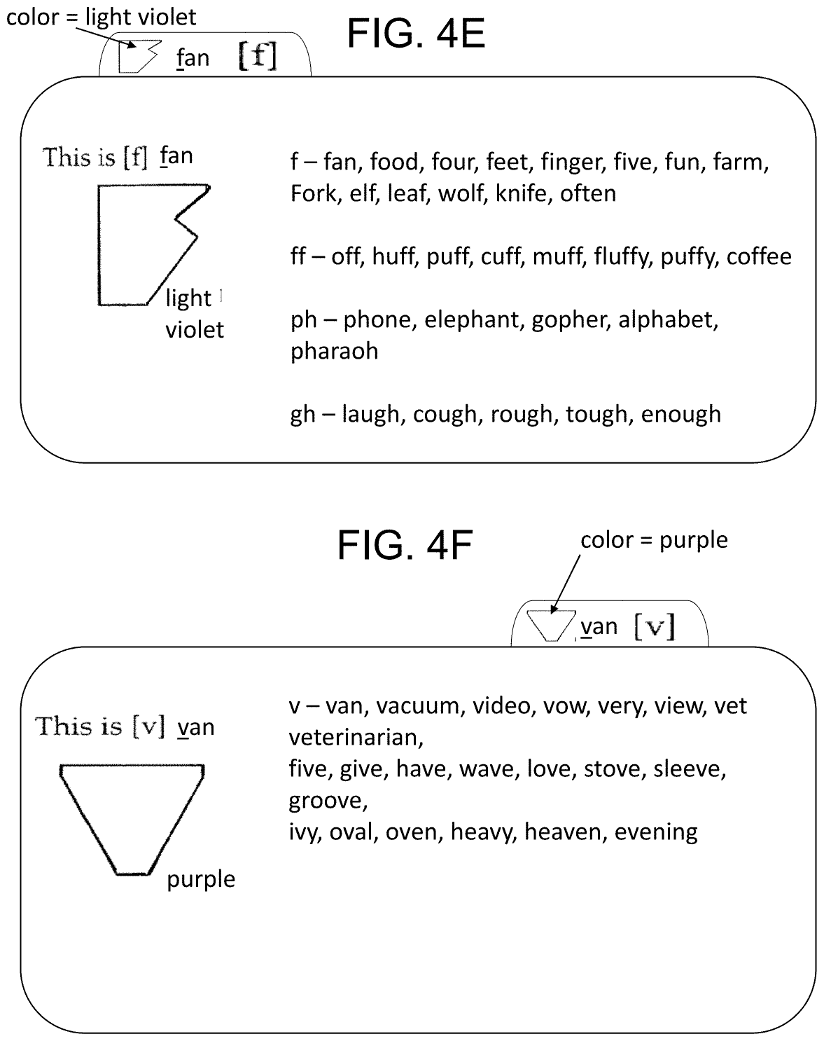

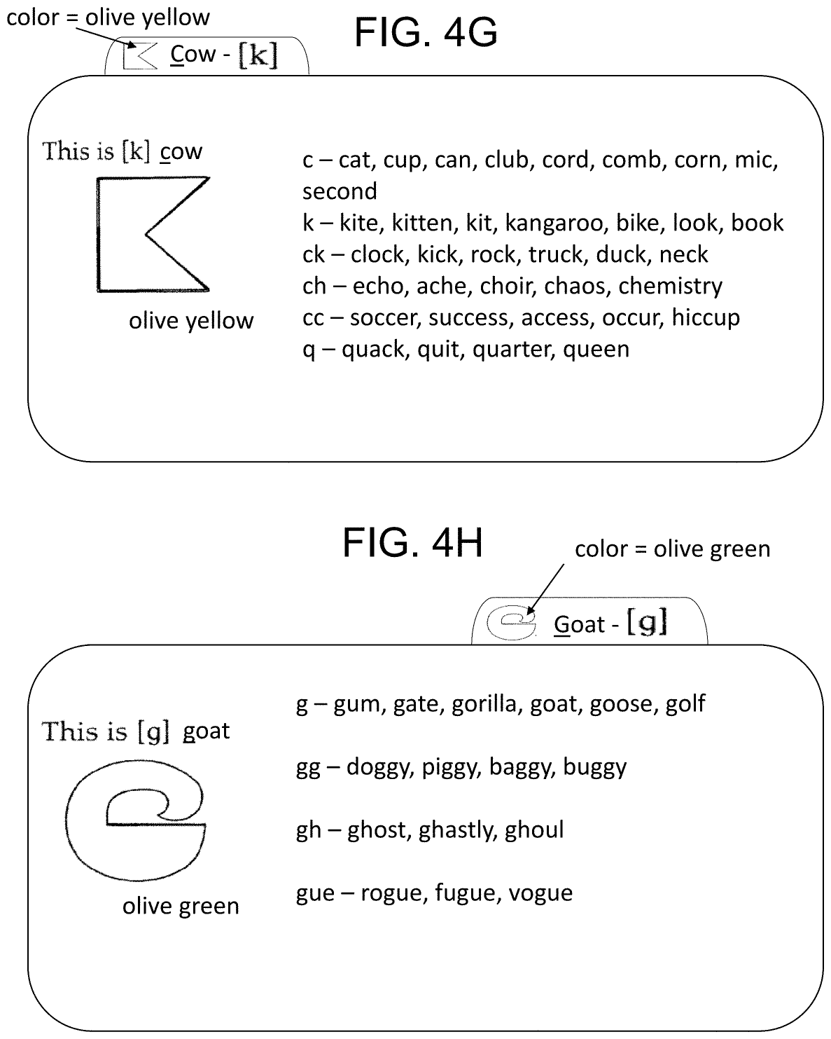

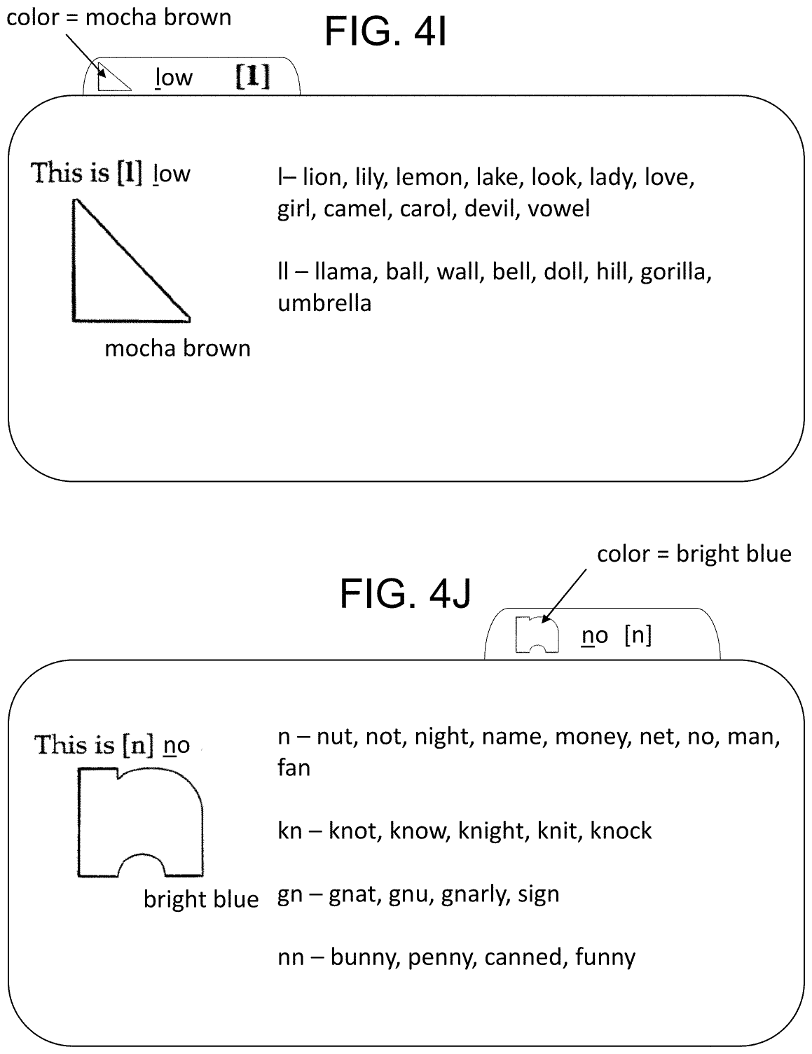

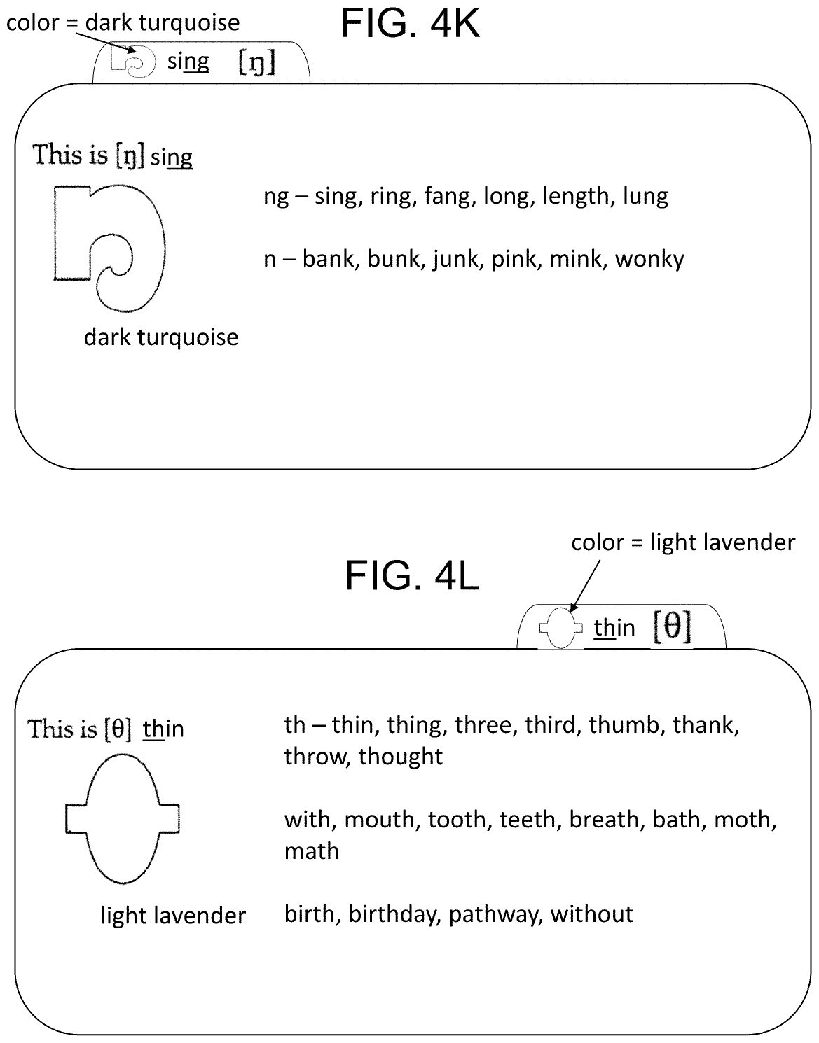

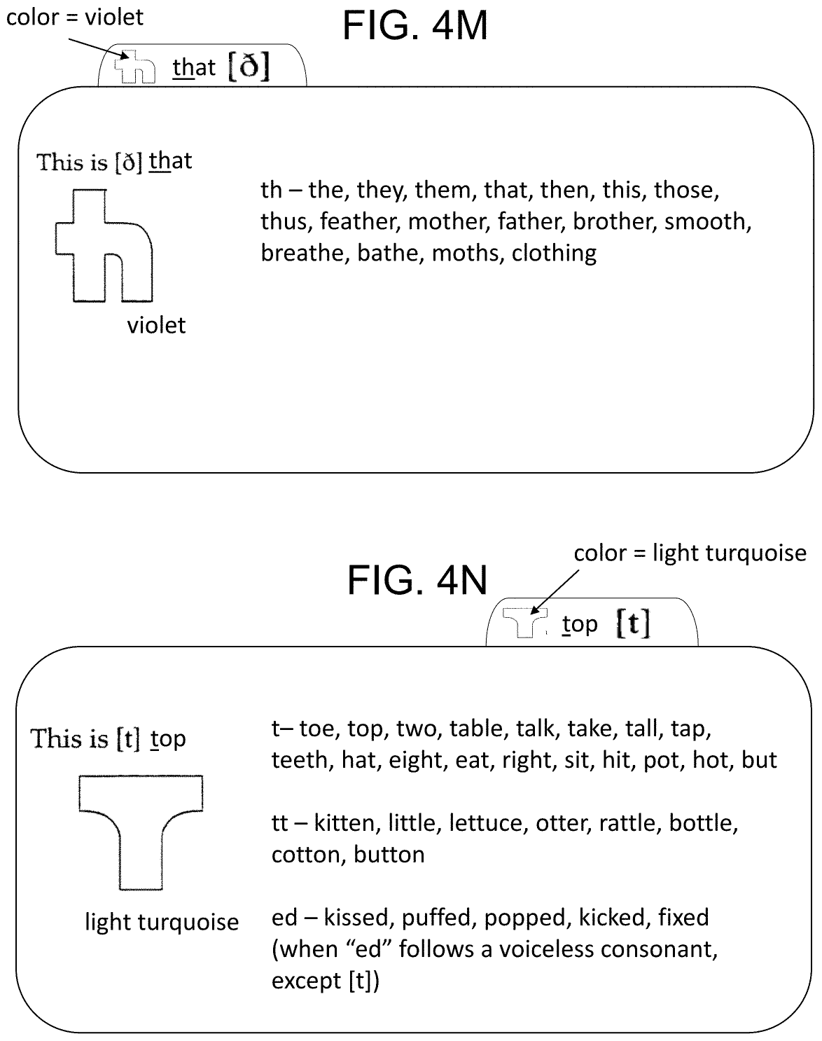

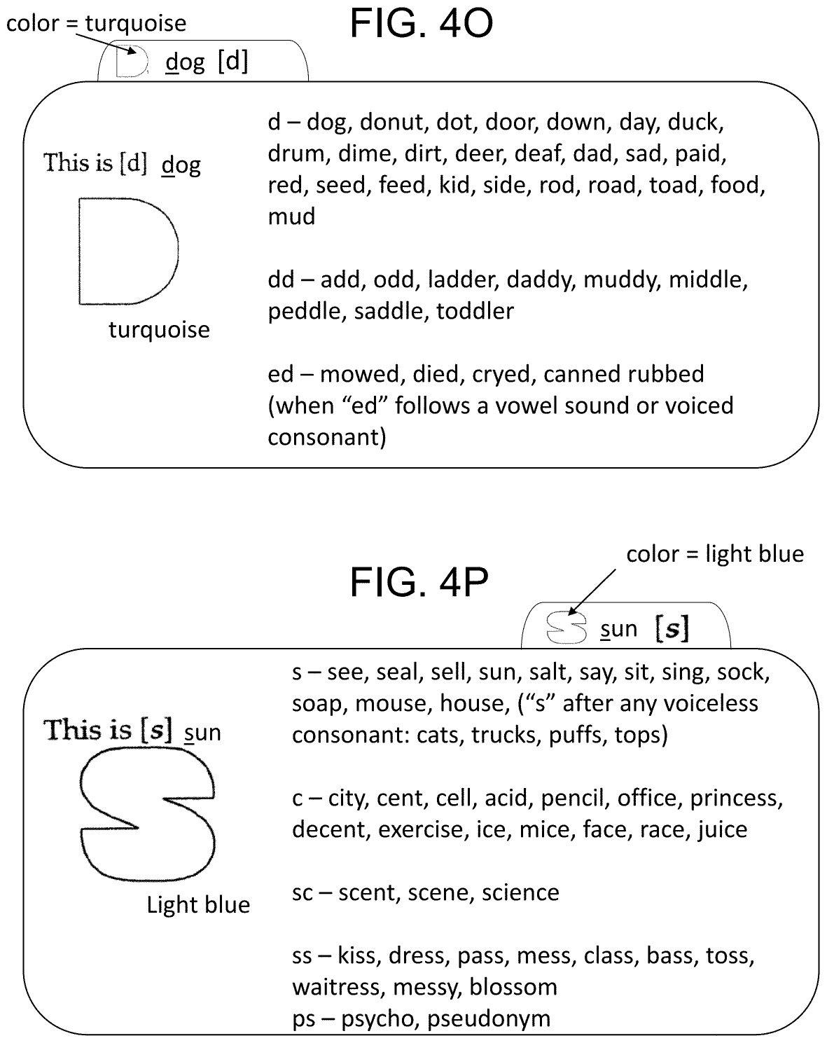

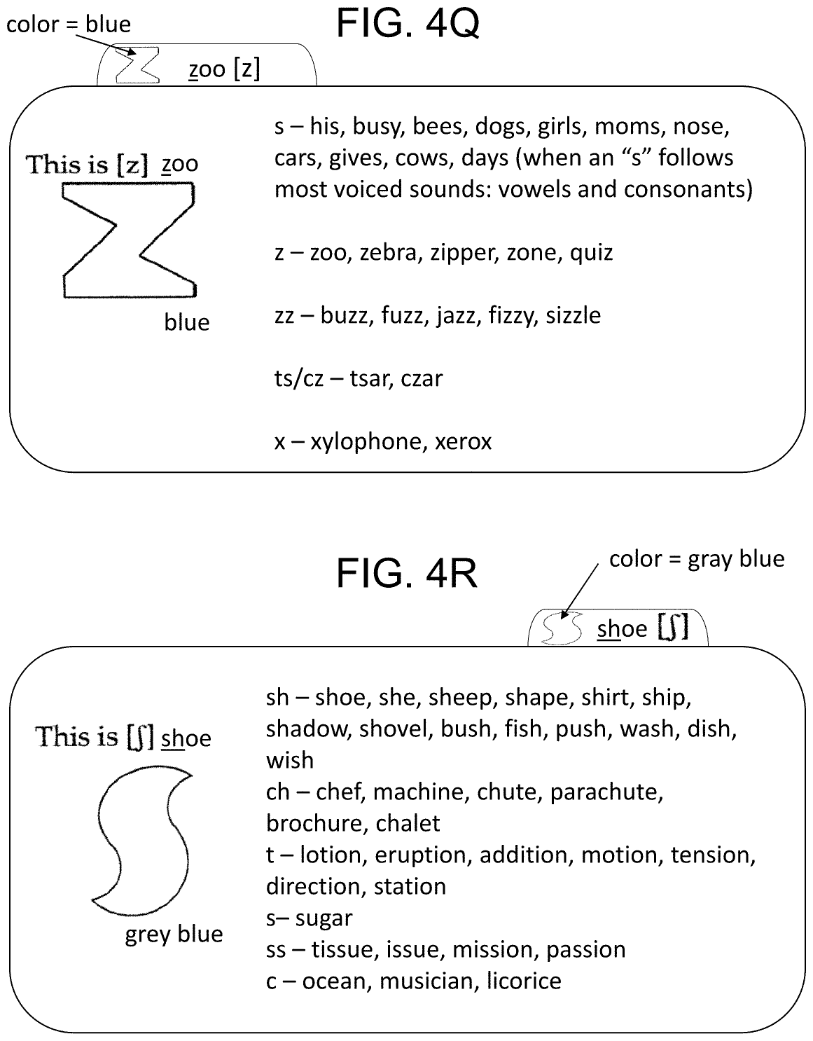

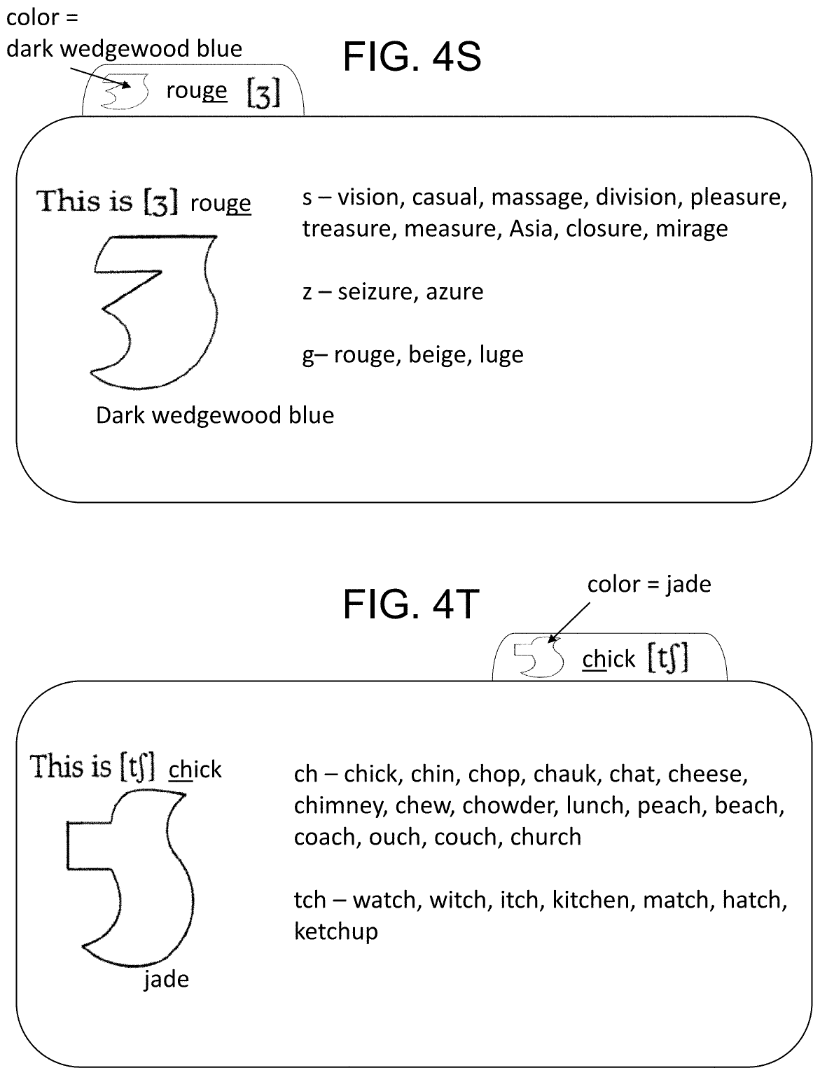

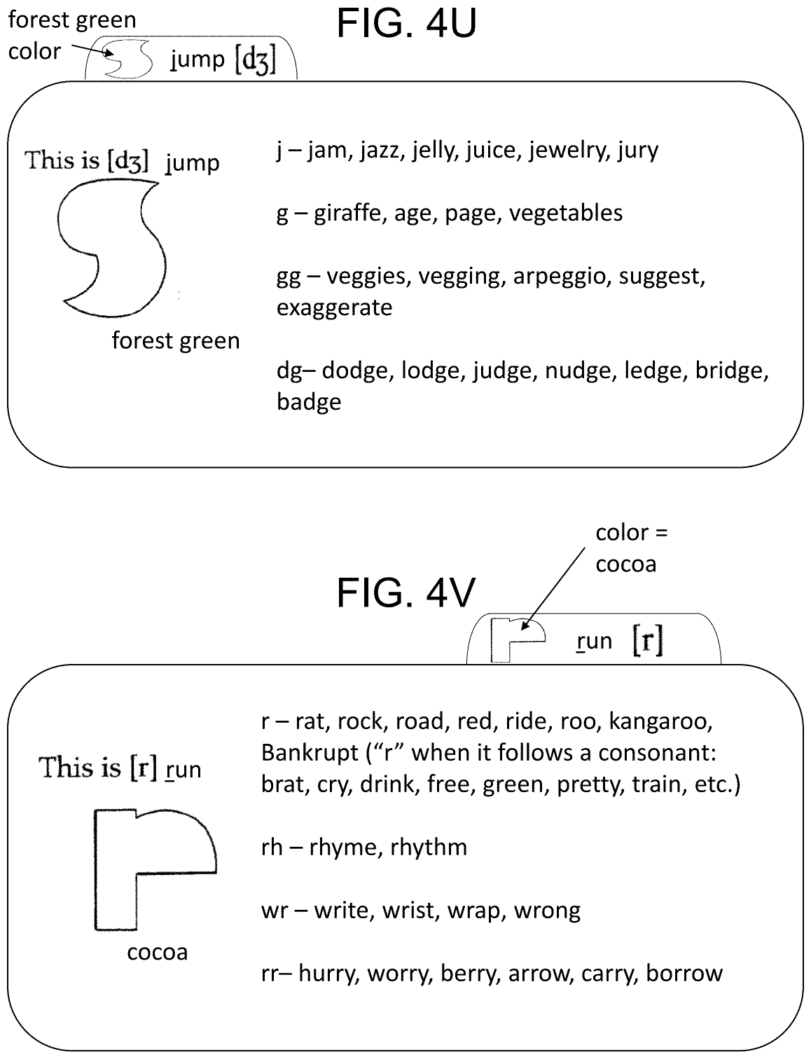

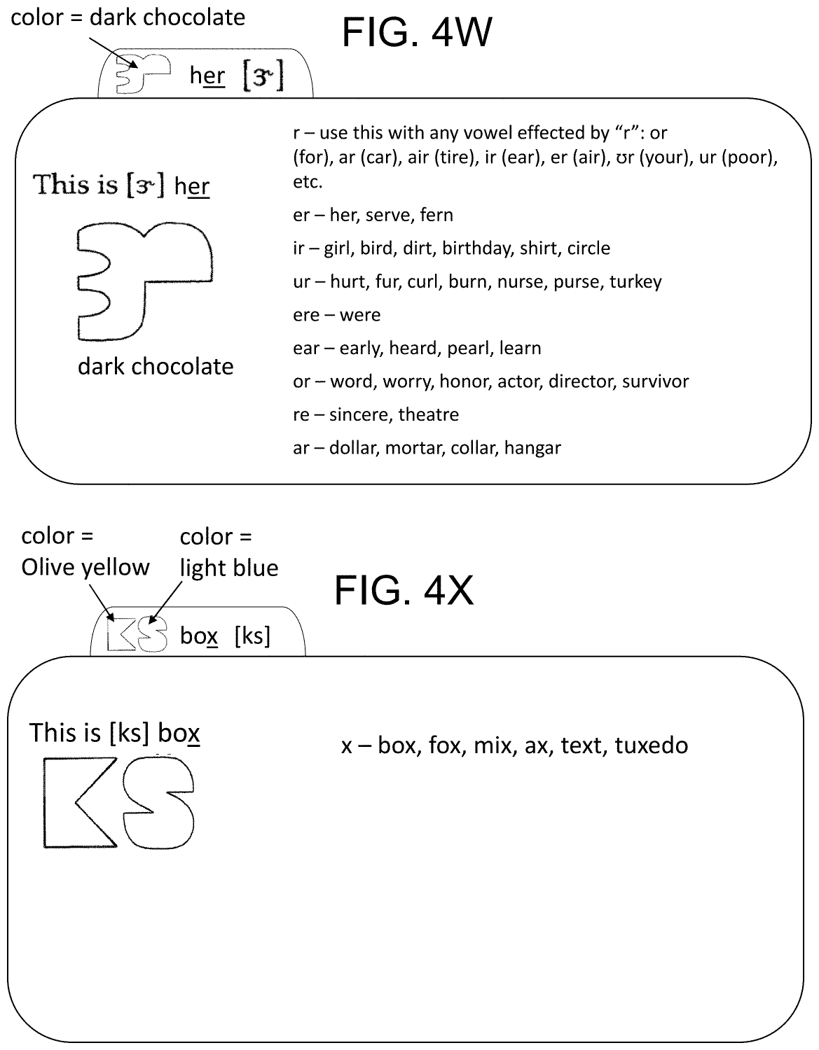

FIG. 4A illustrates the phoneme [p] pronounced like the consonant “p” as used in the word “pie.” In accordance with FIG. 1C as disclosed in Applicant's U.S. Pat. No. 7,172,427, this phoneme [p] is represented by the color “lime green” together with the shape [symbol] . FIG. 4A of the present inventive concept illustrates each of the possible letters and letter combinations that can have the sound of the phoneme [p]. The letter and letter combinations include p and pp. As such, the present inventive concept provides an indicator card (see FIG. 4A) showing these letter and letter combinations as well as applications of these letter combinations used in words having the sound of the phoneme [p], thus helping individuals with hearing impairments and other speech difficulties to pronounce both these sounds and words correctly according to the American English language.

FIG. 4B illustrates the phoneme [b] pronounced like the consonant “b” as used in the word “box.” In accordance with FIG. 1C as disclosed in Applicant's U.S. Pat. No. 7,172,427, this phoneme [b] is represented by the color “green” together with the shape [symbol] . FIG. 4B of the present inventive concept illustrates each of the possible letter and letter combinations that can have the sound of the phoneme [b]. The letter and letter combination include b and bb. As such, the present inventive concept provides an indicator card (see FIG. 4B) showing the and letter combination as well as applications of the letter and letter combination used in words having the sound of the phoneme [b], thus helping individuals with hearing impairments and other speech difficulties to pronounce both these sounds and words correctly according to the American English language.

FIG. 4C illustrates the phoneme [m] pronounced like the consonant “m” as used in the word “mom.” In accordance with FIG. 1C as disclosed in Applicant's U.S. Pat. No. 7,172,427, this phoneme [m] is represented by the color “royal blue” together with the shape [symbol] . FIG. 4C of the present inventive concept illustrates each of the possible letters and letter combinations that can have the sound of the phoneme [m]. These letters and letter combinations include m, mb and mm. As such, the present inventive concept provides an indicator card (see FIG. 4C) showing the letter and letter combinations as well as applications of these letter and letter combinations used in words having the sound of the phoneme [m], thus helping individuals with hearing impairments and other speech difficulties to pronounce both these sounds and words correctly according to the American English language.

FIG. 4D illustrates the phoneme [h] pronounced like the consonant “h” as used in the word “hat.” In accordance with FIG. 1C as disclosed in Applicant's U.S. Pat. No. 7,172,427, this phoneme [h] is represented by the color “white” together with the shape [symbol] . FIG. 4D of the present inventive concept illustrates each of the possible letters and letter combinations that can have the sound of the phoneme [h]. The letter and letter combination include h and wh. As such, the present inventive concept provides an indicator card (see FIG. 4D) showing the letter and letter combination as well as applications of the letter and letter combination used in words having the sound of the phoneme [h], thus helping individuals with hearing impairments and other speech difficulties to pronounce both these sounds and words correctly according to the American English language.

FIG. 4E illustrates the phoneme [f] pronounced like the consonant “f” as used in the word “fan.” In accordance with FIG. 1C as disclosed in Applicant's U.S. Pat. No. 7,172,427, this phoneme [f] is represented by the color “light violet” together with the shape [symbol] . FIG. 4E of the present inventive concept illustrates each of the possible letter and letter combinations that can have the sound of the phoneme [f]. The letter and letter combinations include f, ff, ph and gh. As such, the present inventive concept provides an indicator card (see FIG. 4E) showing the letter and letter combinations as well as applications of the letter and letter combinations used in words having the sound of the phoneme [f], thus helping individuals with hearing impairments and other speech difficulties to pronounce both these sounds and words correctly according to the American English language.

FIG. 4F illustrates the phoneme [v] pronounced like the consonant “v” as used in the word “van.” In accordance with FIG. 1C of the related art as invented by Applicant, this phoneme [v] is represented by the color “purple” together with the shape [symbol] . FIG. 4F of the present inventive concept illustrates each of the possible letters that can have the sound of the phoneme [v]. These letters include v. As such, the present inventive concept provides an indicator card (see FIG. 4F) showing this letter as well as applications of this letter used in words having the sound of the phoneme [v], thus helping individuals with hearing impairments and other speech difficulties to pronounce both the sound and words correctly according to the American English language.

FIG. 4G illustrates the phoneme [k] pronounced like the consonant “k” as used in the word “cow.” In accordance with FIG. 1C as disclosed in Applicant's U.S. Pat. No. 7,172,427, this phoneme [k] is represented by the color “olive yellow” together with the shape [symbol] . FIG. 4G of the present inventive concept illustrates each of the possible letters and letter combinations that can have the sound of the phoneme [k]. These letters and letter combinations include c, k, ck, ch, cc and q. As such, the present inventive concept provides an indicator card (see FIG. 4G) showing these letters and letter combinations as well as applications of these letters and letter combinations used in words having the sound of the phoneme [k], thus helping individuals with hearing impairments and other speech difficulties to pronounce both these sounds and words correctly according to the American English language.

FIG. 4H illustrates the phoneme [g] pronounced like the consonant “g” as used in the word “goat.” In accordance with FIG. 1C as disclosed in Applicant's U.S. Pat. No. 7,172,427, this phoneme [g] is represented by the color “olive green” together with the shape [symbol] . FIG. 4H of the present inventive concept illustrates each of the possible letters and letter combinations that can have the sound of the phoneme [g]. These letter and letter combinations include g, gg, gh and gue. As such, the present inventive concept provides an indicator card (see FIG. 4H) showing the letter and letter combinations as well as applications of the letter and letter combinations used in words having the sound of the phoneme [g], thus helping individuals with hearing impairments and other speech difficulties to pronounce both these sounds and words correctly according to the American English language.

FIG. 4I illustrates the phoneme [l] pronounced like the consonant “l” as used in the word “low.” In accordance with FIG. 1D as disclosed in Applicant's U.S. Pat. No. 7,172,427, this phoneme [l] is represented by the color “mocha brown” together with the shape [symbol] . FIG. 4I of the present inventive concept illustrates each of the possible letters and letter combinations that can have the sound of the phoneme [l]. These letter and letter combinations include l and ll. As such, the present inventive concept provides an indicator card (see FIG. 4I) showing the letter and letter combination as well as applications of the letter and letter combination used in words having the sound of the phoneme [l], thus helping individuals with hearing impairments and other speech difficulties to pronounce both these sounds and words correctly according to the American English language.

FIG. 4J illustrates the phoneme [n] pronounced like the consonant “n” as used in the word “no.” In accordance with FIG. 1D as disclosed in Applicant's U.S. Pat. No. 7,172,427, this phoneme [n] is represented by the color “bright blue” together with the shape [symbol] . FIG. 4J of the present inventive concept illustrates each of the possible letter and letter combinations that can have the sound of the phoneme [n]. The letter and letter combinations include n, kn, gn and nn. As such, the present inventive concept provides an indicator card (see FIG. 4I) showing the letter and letter combinations as well as applications of the letter and letter combinations used in words having the sound of the phoneme [n], thus helping individuals with hearing impairments and other speech difficulties to pronounce both these sounds and words correctly according to the American English language.

FIG. 4K illustrates the phoneme [ [symbol] ] pronounced like the sound of the combined consonants as used in the word “sing.” In accordance with FIG. 1D as disclosed in Applicant's U.S. Pat. No. 7,172,427, this phoneme [ [symbol] ] is represented by the color “dark turquoise” together with the shape [symbol] . FIG. 4K of the present inventive concept illustrates each of the possible letter and letter combinations that can have the sound of the phoneme [ [symbol] ]. The letter and letter combinations include l and ll. As such, the present inventive concept provides an indicator card (see FIG. 4K) showing the letter and letter combination as well as applications of the letter and letter combination used in words having the sound of the phoneme [ [symbol] ], thus helping individuals with hearing impairments and other speech difficulties to pronounce both these sounds and words correctly according to the American English language.

FIG. 4L illustrates the phoneme [θ] pronounced like the combination of consonants “th” as used in the word “thin.” In accordance with FIG. 1D as disclosed in Applicant's U.S. Pat. No. 7,172,427, this phoneme [θ] is represented by the color “light lavender” together with the shape [symbol] . FIG. 4L of the present inventive concept illustrates each of the possible letter and letter combinations that can have the sound of the phoneme [θ]. The letter combinations include th. As such, the present inventive concept provides an indicator card (see FIG. 4L) showing the letter combination as well as applications of the letter combination used in words having the sound of the phoneme [θ], thus helping individuals with hearing impairments and other speech difficulties to pronounce both the sound and words correctly according to the American English language.

FIG. 4M illustrates the phoneme [ð] pronounced like the combined consonants “th” as used in the word “that.” In accordance with FIG. 1D as disclosed in Applicant's U.S. Pat. No. 7,172,427, this phoneme [ð] is represented by the color “violet” together with the shape [symbol] . FIG. 4M of the present inventive concept illustrates each of the possible letter combinations that can have the sound of the phoneme [ð]. The letter combinations include th. As such, the present inventive concept provides an indicator card (see FIG. 4M) showing the letter combination as well as applications of the letter combination used in words having the sound of the phoneme [ð], thus helping individuals with hearing impairments and other speech difficulties to pronounce both the sound and words correctly according to the American English language.

FIG. 4N illustrates the phoneme [t] pronounced like the consonant “t” as used in the word “top.” In accordance with FIG. 1D as disclosed in Applicant's U.S. Pat. No. 7,172,427, this phoneme [t] is represented by the color “light turquoise” together with the shape [symbol] . FIG. 4N of the present inventive concept illustrates each of the possible letter and letter combinations that can have the sound of the phoneme [t]. The letter and letter combinations include t, tt and ed. As such, the present inventive concept provides an indicator card (see FIG. 4N) showing the letter and letter combinations as well as applications of the letter and letter combinations used in words having the sound of the phoneme [t], thus helping individuals with hearing impairments and other speech difficulties to pronounce both the sound and words correctly according to the American English language.

FIG. 4O illustrates the phoneme [d] pronounced like the consonant “d” as used in the word “dog.” In accordance with FIG. 1D as disclosed in Applicant's U.S. Pat. No. 7,172,427, this phoneme [d] is represented by the color “turquoise” together with the shape [symbol] . FIG. 4O of the present inventive concept illustrates each of the possible letter and letter combinations that can have the sound of the phoneme [d]. The letter and letter combinations include d, dd and ed. As such, the present inventive concept provides an indicator card (see FIG. 4O) showing the letter and letter combinations as well as applications of the letter and letter combinations used in words having the sound of the phoneme [d], thus helping individuals with hearing impairments and other speech difficulties to pronounce both the sound and words correctly according to the American English language.

FIG. 4P illustrates the phoneme [s] pronounced like the consonant “s” as used in the word “sun.” In accordance with FIG. 1E of the related art as invented by Applicant, this phoneme [s] is represented by the color “light blue” together with the shape [symbol] . FIG. 4P of the present inventive concept illustrates each of the possible letter and letter combinations that can have the sound of the phoneme [s]. The letter and letter combinations includes c, sc, ss and ps. As such, the present inventive concept provides an indicator card (see FIG. 4P) showing the letter and letter combinations as well as applications of the letter and letter combinations used in words having the sound of the phoneme [s], thus helping individuals with hearing impairments and other speech difficulties to pronounce both the sound and words correctly according to the American English language.

FIG. 4Q illustrates the phoneme [z] pronounced like the consonant “z” as used in the word “zoo.” In accordance with FIG. 1E as disclosed in Applicant's U.S. Pat. No. 7,172,427, this phoneme [z] is represented by the color “blue” together with the shape [symbol] . FIG. 4Q of the present inventive concept illustrates each of the possible letters and letter combinations that can have the sound of the phoneme [z]. The letters and letter combinations includes s, z, zz, ts/cz and x. As such, the present inventive concept provides an indicator card (see FIG. 4Q) showing the letters and letter combinations as well as applications of the letter and letter combinations used in words having the sound of the phoneme [z], thus helping individuals with hearing impairments and other speech difficulties to pronounce both these sound and words correctly according to the American English language.

FIG. 4R illustrates the phoneme [∫] pronounced like the combination of consonants “sh” as used in the word “shoe.” In accordance with FIG. 1E as disclosed in Applicant's U.S. Pat. No. 7,172,427, this phoneme [∫] is represented by the color “gray blue” together with the shape [symbol] . FIG. 4R of the present inventive concept illustrates each of the possible letters and letter combinations that can have the sound of the phoneme [∫]. The letters and letter combinations includes sh, ch, t, s, ss and c. As such, the present inventive concept provides an indicator card (see FIG. 4R) showing the letters and letter combinations as well as applications of the letters and letter combinations used in words having the sound of the phoneme [∫], thus helping individuals with hearing impairments and other speech difficulties to pronounce both the sounds and words correctly according to the American English language.

FIG. 4S illustrates the phoneme [ [symbol] ] pronounced like the combination of letters g and e as used in the word “rouge.” In accordance with FIG. 1E as disclosed in Applicant's U.S. Pat. No. 7,172,427, this phoneme [ [symbol] ] is represented by the color “dark wedgewood blue” together with the shape [symbol] . FIG. 4S of the present inventive concept illustrates each of the possible letters that can have the sound of the phoneme [ [symbol] ]. The letters include s, z, and g. As such, the present inventive concept provides an indicator card (see FIG. 4S) showing the letters as well as applications of these letters used in words having the sound of the phoneme [ [symbol] ], thus helping individuals with hearing impairments and other speech difficulties to pronounce both the sound and words correctly according to the American English language.

FIG. 4T illustrates the phoneme [t∫] pronounced like the combination of consonants “ch” as used in the word “chick.” In accordance with FIG. 1E as disclosed in Applicant's U.S. Pat. No. 7,172,427, this phoneme [t∫] is represented by the color “jade” together with the shape [symbol] . FIG. 4T of the present inventive concept illustrates each of the possible letter combinations that can have the sound of the phoneme [t∫]. The letters combinations include ch and tch. As such, the present inventive concept provides an indicator card (see FIG. 4T) showing the letter combinations as well as applications of the letter combinations used in words having the sound of the phoneme [t∫], thus helping individuals with hearing impairments and other speech difficulties to pronounce both the sound and words correctly according to the American English language.

FIG. 4U illustrates the phoneme [ [symbol] ] pronounced like the consonant “j” as used in the word “jump.” In accordance with FIG. 1E of the related art as invented by Applicant, this phoneme [d [symbol] ] is represented by the color “forest green” together with the shape [symbol] . FIG. 4U of the present inventive concept illustrates each of the possible letter and letter combinations that can have the sound of the phoneme [ [symbol] ]. The letters and letter combinations include j, g, gg and dg. As such, the present inventive concept provides an indicator card (see FIG. 4U) showing the letters and letter combinations as well as applications of the letters and letter combinations used in words having the sound of the phoneme [ [symbol] ], thus helping individuals with hearing impairments and other speech difficulties to pronounce both the sound and words correctly according to the American English language.

FIG. 4V illustrates the phoneme [r] pronounced like the consonant “r” as used in the word “run.” In accordance with FIG. 1E as disclosed in Applicant's U.S. Pat. No. 7,172,427, this phoneme [r] is represented by the color “cocoa” together with the shape [symbol] . FIG. 4V of the present inventive concept illustrates each of the possible letter and letter combinations that can have the sound of the phoneme [r]. The letter and letter combinations include r, rh, wr and rr. As such, the present inventive concept provides an indicator card (see FIG. 4V) showing the letter and letter combinations as well as applications of the letter and letter combinations used in words having the sound of the phoneme [r], thus helping individuals with hearing impairments and other speech difficulties to pronounce both the sound and words correctly according to the American English language.

FIG. 4W illustrates the phoneme [ [symbol] ] pronounced like the combined letters “er” as used in the word “her.” In accordance with FIG. 1E as disclosed in Applicant's U.S. Pat. No. 7,172,427, this phoneme [ [symbol] ] is represented by the color “dark chocolate” together with the shape [symbol] . FIG. 4W of the present inventive concept illustrates each of the possible letter and letter combinations that can have the sound of the phoneme [ [symbol] ]. The letter and letter combinations include r, er, ir, ur, ere, ear, or, re and ar. As such, the present inventive concept provides an indicator card (see FIG. 4W) showing the letter and letter combinations as well as applications of the letter and letter combinations used in words having the sound of the phoneme [ [symbol] ], thus helping individuals with hearing impairments and other speech difficulties to pronounce both the sound and words correctly according to the American English language.

FIG. 4X illustrates the phoneme [ks] pronounced like the consonant “x” as used in the word “box.” In accordance with FIG. 4X, this phoneme [ks] is represented by the combination of colors “olive yellow” and “light blue” together with the shapes [symbol] . More specifically, the shape [symbol] is provided in olive yellow and the shape [symbol] is provided in light blue. FIG. 4X of the present inventive concept illustrates each of the letters that can have the sound of the phoneme [ks]. The letters include x. As such, the present inventive concept provides an indicator card (see FIG. 4X) showing the letter as well as applications of the letter used in words having the sound of the phoneme [ks], thus helping individuals with hearing impairments and other speech difficulties to pronounce both the sound and words correctly according to the American English language.

Although a specific color(s) and a specific shape(s) in accordance with the examplary embodiment as illustrated in FIGS. 4A through 4X are used to represent each of the consonant phonemes and combined consonant phonemes listed in the International Phonetic Alphabet illustrated in FIG. 2B, each of these phonemes could be represented by another color and/or shape without departing from the principles, scope and spirit of the present inventive concept as disclosed herein.

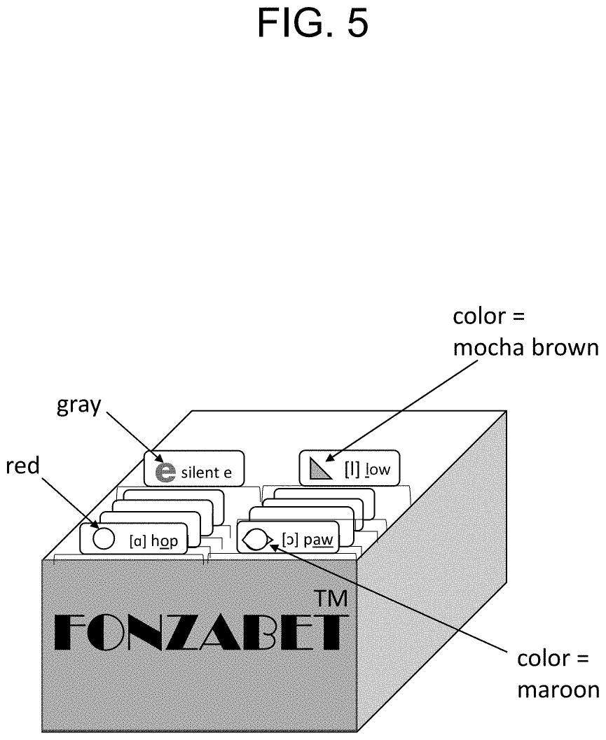

FIG. 5 illustrates the system described with respect to FIGS. 3A through 4X contained in a kit or containerized collection in accordance with an exemplary embodiment of the present inventive concept. Each of the index cards can be alternatively arranged such that the top tabs of each of the index cards can been seen while in the kit or container.

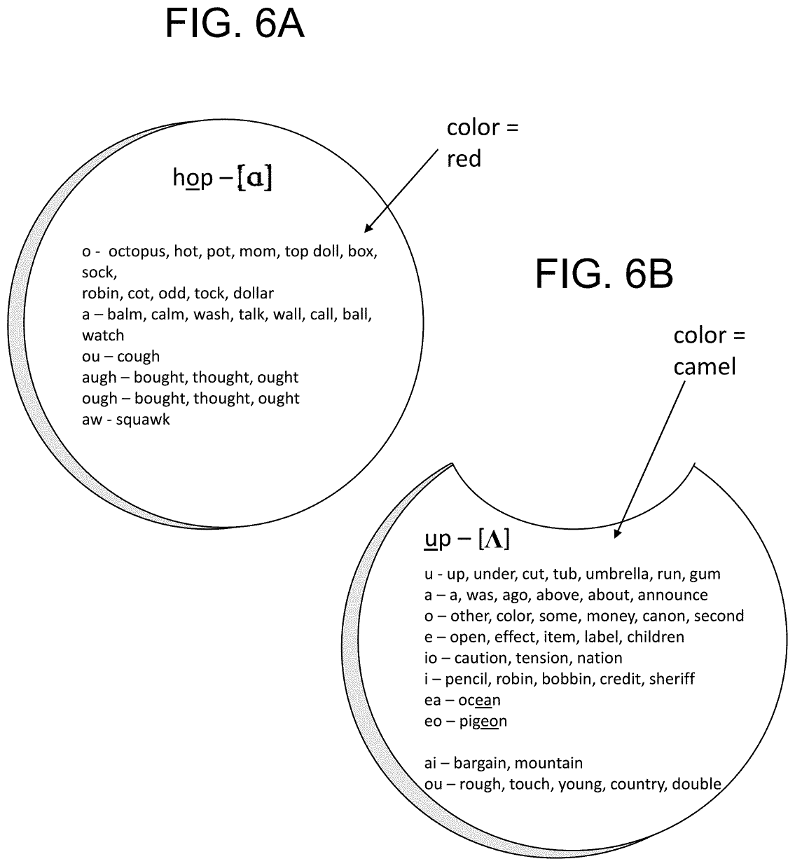

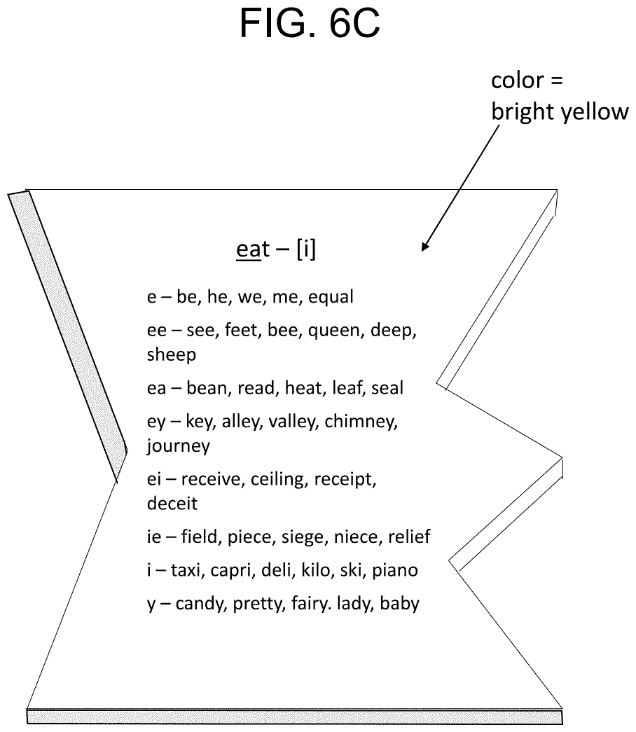

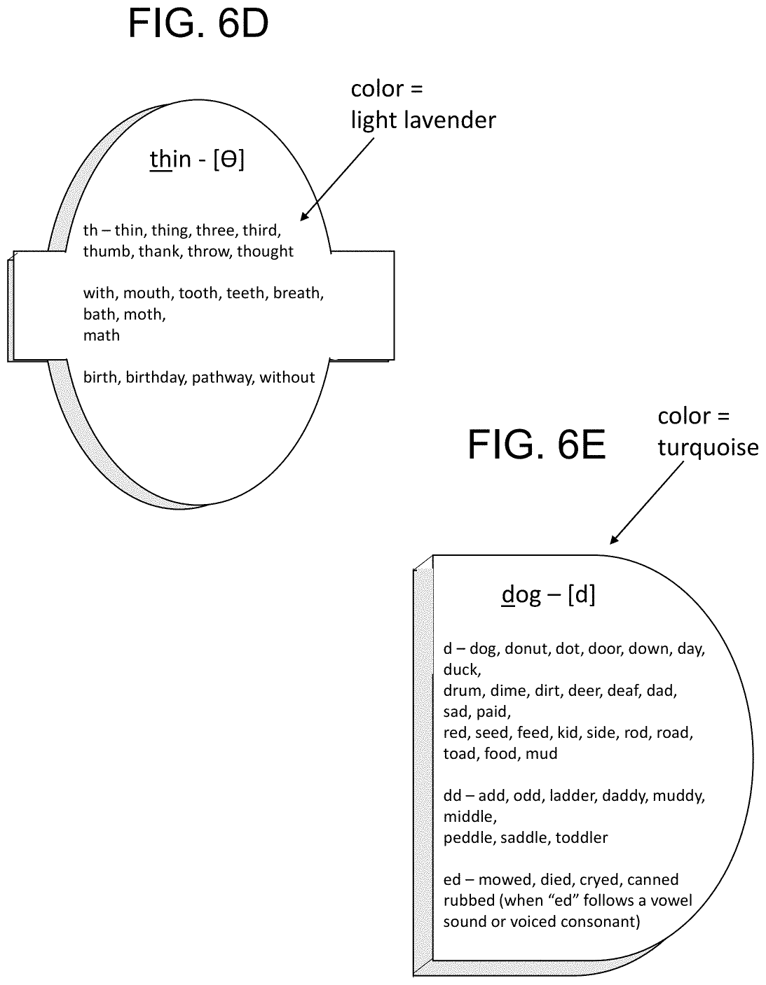

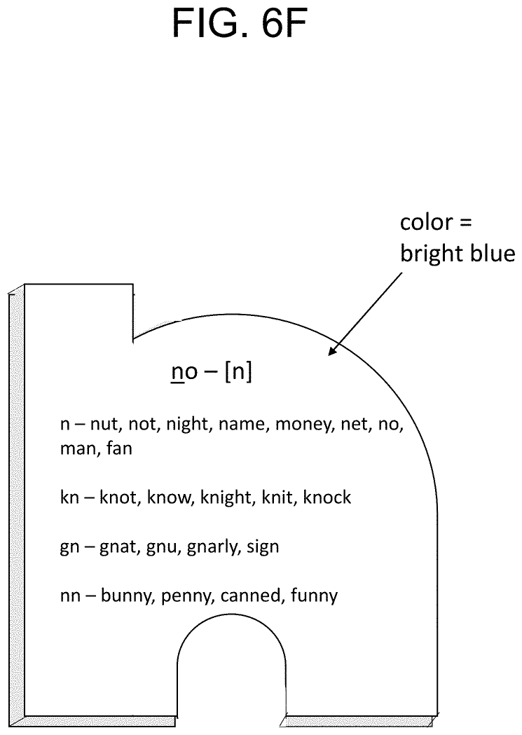

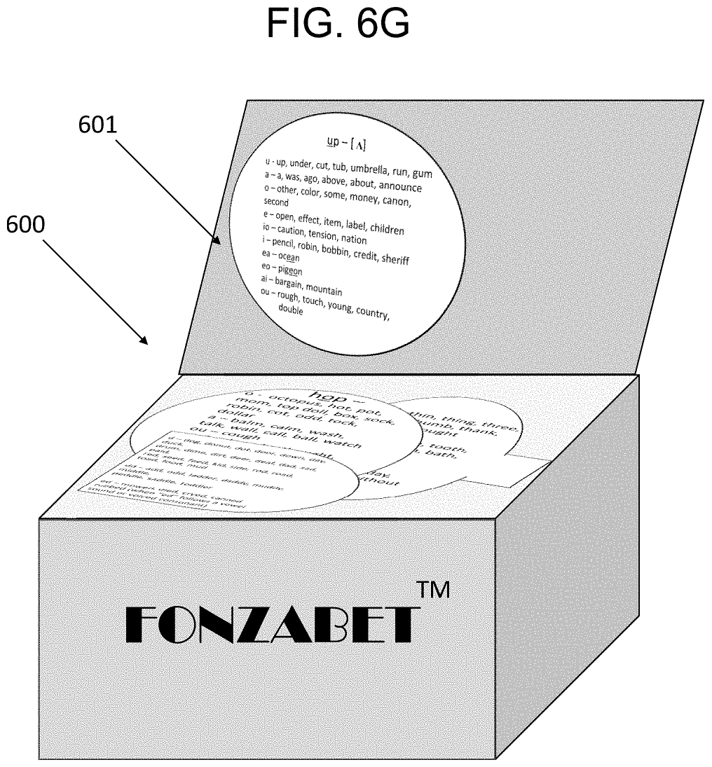

FIGS. 6A through 6D illustrate a system and process for teaching all of the American English language phoneme vowel sounds, consonant sound, vowel combination sounds and consonant combinations sounds to those with hearing and/or speech disabilities, according to another exemplary embodiment of the present inventive concept. More specifically, similar to the index card system and process described above and illustrated in FIGS. 3A through 4X, a complete system and process is provided for teaching all of the American English language phoneme vowel sounds, consonant sound, vowel combination sounds and consonant combinations sounds to those with hearing and/or speech disabilities, according to another exemplary embodiment of the present inventive concept. However, this system and process is provided in the form of three dimensional elements fabricated to a certain thickness and proportion suitable for physical demonstration or application. FIGS. 6A through 6D are just a few examples of the three dimensional elements according to this exemplary embodiment, and a complete set of three dimensional elements that are equal in number to the multiple index cards illustrated in FIGS. 3A through 4X are provided to represent each of the phonemes of the American English language.

FIG. 6A illustrates a three dimensional element for the phoneme [α]. Written on the three dimensional element for the phoneme [α] is the word hop, illustrating the pronunciation of this phoneme. Also written on the three dimensional element for the phoneme [α] are each of the vowel and vowel combinations that are used to spell words using this phoneme sound, together with words including these vowel and vowel combinations. Moreover, this three dimensional element for the phoneme [α] can also be provided in the color “red” to represent the phoneme sound for phoneme [α], similar to the index card according to the exemplary embodiment illustrated in FIG. 3I.

FIG. 6B illustrates a three dimensional element for the phoneme [Λ]. Written on the three dimensional element for the phoneme [Λ] is the word up, illustrating the pronunciation of this phoneme. Also written on the three dimensional element for the phoneme [Λ] are each of the vowel and vowel combinations that are used to spell words using this phoneme sound, together with words including these vowel and vowel combinations. Moreover, this three dimensional element for the phoneme [Λ] can also be provided in the color “camel” to represent the phoneme sound for phoneme [Λ], similar to the index card according to the exemplary embodiment illustrated in FIG. 3A.

FIG. 6C illustrates a three dimensional element for the phoneme [i]. Written on the three dimensional element for the phoneme [i] is the word eat, illustrating the pronunciation of this phoneme. Also written on the three dimensional element for the phoneme [i] are each of the vowel and vowel combinations that are used to spell words using this phoneme sound, together with words including these vowel and vowel combinations. Moreover, this three dimensional element for the phoneme [i] can also be provided in the color “bright yellow” to represent the phoneme sound for phoneme [i], similar to the index card according to the exemplary embodiment illustrated in FIG. 3F.

FIG. 6D illustrates a three dimensional element for the phoneme [θ]. Written on the three dimensional element for the phoneme [θ] is the word thin, illustrating the pronunciation of this phoneme. Also written on the three dimensional element for the phoneme [θ] is the consonant combination that is used to spell words using this phoneme sound, together with words including this consonant combinations. Moreover, this three dimensional element for the phoneme [θ] can also be provided in the color “light lavender” to represent the phoneme sound for phoneme [θ], similar to the index card according to the exemplary embodiment illustrated in FIG. 4L.

FIG. 6E illustrates a three dimensional element for the phoneme [d]. Written on the three dimensional element for the phoneme [θ] is the word thin, illustrating the pronunciation of this phoneme. Also written on the three dimensional element for the phoneme [d] are consonant and consonant combinations that are used to spell words using this phoneme sound, together with words including the consonant and consonant combinations. Moreover, this three dimensional element for the phoneme [d] can also be provided in the color “turquoise” to represent the phoneme sound for phoneme [d], similar to the index card according to the exemplary embodiment illustrated in FIG. 4O.

FIG. 6F illustrates a three dimensional element for the phoneme [n]. Written on the three dimensional element for the phoneme [n] is the word no, illustrating the pronunciation of this phoneme. Also written on the three dimensional element for the phoneme [n] are consonant and consonant combinations that are used to spell words using this phoneme sound, together with words including the consonant and consonant combinations. Moreover, this three dimensional element for the phoneme [n] can also be provided in the color “bright blue” to represent the phoneme sound for phoneme [n], similar to the index card according to the exemplary embodiment illustrated in FIG. 4J.

FIGS. 6A through 6F provide only a small number of the three dimensional elements according to this exemplary system and process. FIGS. 6A through 6F illustrate three examples representing phoneme vowels and vowel combinations and three examples representing phoneme consonants and consonant combinations, together with words using the phoneme vowels and vowel combinations and phoneme consonants and consonant combinations. Only six examples of the three dimensional elements are illustrated in order to provide brevity to the detailed description herein. However, the number of three dimensional elements can be equal in number to the number of index cards described and illustrated in the exemplary embodiments of FIGS. 3A through 4X, as well as providing the same information thereon. Moreover, as more phonemes may be added to the International Phonetic Chart, additional three dimensional elements may be added with corresponding vowel and/or vowel combinations (or consonant and/or consonant combinations) together with words using the same, along with unique colors and shapes to represent such newly added vowel and/or vowel combinations (or consonant and/or consonant combinations) without departing from the spirit of the present inventive concept.

The three dimensional elements according to this exemplary embodiment can be provided with a substantially rigid construction such that the visual phonemes enjoy the advantage of being capable of incorporating (in the fabrication thereof or attached thereto) magnetic characteristics for attachment to metal surfaces, as for example cabinets or refrigerator doors, as learning reminders. Alternatively, such substantially rigid elements may take forms (not shown) similar to well-known building blocks or provided with other structural capabilities of special application to playful learning. The solid or substantially rigid form of visual phoneme shown in FIGS. 6A through 6D also are considerably more durable and more easily cleaned.

These three dimensional elements can also be constructed of felt or felt-like material providing a substantially soft, flexible or malleable profile, or can be constructed of, for example, substantially rigid materials such as wood, ceramic, metal, plastic, tag board, or cardboard. It is to be noted that the system according to this exemplary embodiment is not limited to the few examples listed above, but can be constructed of any type of material(s), or digital representations, that provide the intended purposes of the present inventive concept, as described herein.

The shape of a representative visual phoneme in accordance with this inventive system and process may also be reminiscent of the Roman alphabet with which it is most often associated. As an example, FIG. 6C illustrates the visual phoneme [i] having the long vowel sound made when sounding the letter E. This phoneme is uniquely designated by the color bright yellow, notably corresponding with FIG. 3F.

FIG. 6G illustrates a system the system described with respect to FIGS. 6A through 6F contained in a kit 600 (or containerized collection) in accordance with an exemplary embodiment of the present inventive concept. Each of the three dimensional elements can be stored in the kit 600 for transportation or storage. The kit 600 can include a cover 601 that can open to a certain angle and act as a board to display one or more of the elements for viewing and teaching. The inside of the cover 601 can be made of a magnetic metal when the elements are made of a magnetic material, a Velcro type material when the elements have a Velcro backing, or any other attractive type of material such that the three dimensional elements can be removably attached to the inside of the cover 601 for display while in use.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a blue-ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system for teaching speech to individuals with hearing or speech disabilities using phonemes, the system comprising:
a plurality of index cards each comprising:
a unique phoneme disposed thereon,
a unique shape disposed thereon to represent the unique phoneme, the unique shape having a unique color also to represent the unique phoneme,
every letter and combination of letters used in the American English language which form the sound of the unique phoneme when spoken, the every letter and combination of letters being provided in the unique color, and
one or more words adjacent to each of the letters and combination of letters thereon, the words being words using the letter or combination of letters therein in a way in which the phoneme is sounded when spoken.

2. The system according to claim 1, further comprising a kit to contain each of the index cards in a predetermined order.

3. The system according to claim 2, wherein the plurality of index cards each comprise a tab at a top portion thereof and at an opposite side from an adjacent index card such that each of the tabs of the index cards are fully in view while the plurality of index cards are disposed in the kit.

4. The system according to claim 3, wherein each of the tabs of the plurality of index cards include the shape and color thereon which represent the respective phoneme, a word with a letter or combination of letters which sound the phoneme, and the respective phoneme adjacent thereto.

5. A system for teaching speech to individuals with hearing or speech disabilities using phonemes, the system comprising:
a plurality of three dimensional elements each comprising:
a unique phoneme disposed thereon,
a unique shape to represent the respective unique phoneme, the unique shape having a unique color also to represent the respective unique phoneme,
a letter or combination of letters used in the American English language which are used to speak the sound of the unique phoneme, the letter or combination of letters being provided in the unique color, and
one or more words adjacent each of respective ones of the letter or combination of letters, the words being ones which use the letter or combination of letters therein in a way in which the phoneme is sounded when spoken.

6. The system according to claim 5, further comprising:
a kit to contain each of the three dimensional elements therein, the kit being enclosed by a front surface, a back surface, two sides and a cover, the cover being rotatable with respect to the back surface to expose the three dimensional elements therein.

7. The system according to claim 6, wherein the three dimensional elements are formed of a magnetic material and the inside of the cover is formed of a magnetically attractive metal to magnetically attract the three dimensional elements thereto.

8. The system according to claim 6, wherein a back surface of the three dimensional elements and the inside surface of the cover are formed of a hook and loop system such that the three dimensional elements attract to and stick to the inside surface of the cover.

9. The system according to claim 6, wherein the three dimensional elements are formed of a flexible material.

10. The system according to claim 9, wherein the three dimensional elements are formed of a felt material.

11. The system according to claim 9, wherein the three dimensional elements are formed of a rubber material.

12. A process of teaching speech to individuals with hearing or speech disabilities, the process comprising:
providing a plurality of two dimensional objects each including a unique phoneme disposed thereon;
providing a unique shape disposed on each of the objects to represent the respective phoneme, each unique shape having a unique color also to represent the respective phoneme;
providing letters and combinations of letters on each of the objects which are used in the American English language to sound the respective phoneme when spoken, the letters and combinations of letters being provided in the unique colors representing the phoneme, and
providing one or more words adjacent to each of the respective letters and combinations of letters which include the adjacent letter or combination of letters therein in a way in which the phoneme is sounded when spoken.

13. A process for teaching speech to individuals with hearing or speech disabilities using phonemes, the process comprising:
providing a plurality of three dimensional objects in a unique shape and color:
providing a unique phoneme on each of the three dimensional objects;
providing letters and combinations of letters used in the American English language which are used to sound of the respective phoneme when spoken; and
providing one or more words adjacent to each of the respective letters and combinations of letters which include the adjacent letter or combination of letters therein in a way in which the phoneme is sounded when spoken.

14. A non-transitory computer-readable medium comprising instructions executed by a processor to:
providing a plurality of three dimensional objects in a unique shape and color:
providing a unique phoneme on each of the three dimensional objects;
providing letters and combinations of letters used in the American English language which are used to sound the respective phoneme when spoken; and
providing one or more words adjacent to each of the respective letters and combinations of letters which include the adjacent letter or combination of letters therein in a way in which the phoneme is sounded when spoken.
